(19) United States
(12) Patent Application Publication
(10) Pub. No.: US 2026/0092862 A1
(43) Pub. Date: Apr. 2, 2026

(54) PRE-TRANSPLANTATION EVALUATION OF HUMAN LIVERS USING OPTICAL COHERENCE TOMOGRAPHY

(71) Applicant: THE BOARD OF REGENTS OF THE UNIVERSITY OF OKLAHOMA, Norman, OK (US)

(72) Inventors: Feng YAN, Norman, OK (US); Qinggong TANG, Norman, OK (US); Chongle PAN, Norman, OK (US); Qinghao ZHANG, Norman, OK (US)

(73) Assignee: THE BOARD OF REGENTS OF THE UNIVERSITY OF OKLAHOMA, Norman, OK (US)

(21) Appl. No.: 19/345,379

(22) Filed: Sep. 30, 2025

Related U.S. Application Data
(60) Provisional application No. 63/700,926, filed on Sep. 30, 2024.
(60) Provisional application No. 63/832,939, filed on Jun. 30, 2025.

(51) Int. Cl. G01N 21/21; A01N 1/00

(52) U.S. Cl. CPC G01N 21/21; A01N 1/00; G01N 2201/0633; G01N 2201/0636

(57) ABSTRACT

Apparatus and associated methods relate to a pre-transplantation evaluation of human livers using optical coherence tomography. In an illustrative example, a computer-implemented method performed by at least one processor to conduct a non-invasive evaluation of a liver prior to a transplantation procedure. The method includes providing a polarization-sensitive optical coherence tomography (PS-OCT) system. The PS-OCT system may, for example, be coupled to a machine-learning-based system trained to evaluate PC-OCT images of liver. The method may, for example, include determining steatosis, fibrosis, inflammation, and necrosis scores for the liver. The method may, for example, determine whether the liver is unsuitable or suitable for use as a donor liver when the steatosis, fibrosis, inflammation, and necrosis scores fail to meet predetermined donor suitability criteria; and, maintaining the liver under proper preservation conditions when the liver is determined to be suitable for use as a donor liver.

### CROSS-REFERENCE TO RELATED APPLICATIONS

The present application claims the priority benefit of U.S. provisional application No. 63/832,939, filed Jun. 30, 2025, and U.S. provisional application No. 63/700,926, filed Sep. 30, 2024, the entire contents of which are incorporated herein by reference.

### STATEMENT OF FEDERALLY SPONSORED RESEARCH

This invention was made with government support under Grant Nos. OIA 2132161 and OIA 2238648 awarded by the National Science Foundation, and Grant Nos. DK133717, GM135009, GM103639, and CA225520 awarded by the National Institutes of Health. The Government has certain rights in the invention.

### BACKGROUND

### 1. Field

The present disclosure relates generally to the field of pre-transplant evaluation. More particularly, it concerns pre-transplantation evaluation of human liver using polarization-sensitive optical coherence tomography.

### 2. Description of Related Art

Human liver transplantation is a standard treatment for certain hepatic cancers and advanced-stage liver chronic diseases. There is a worldwide donor liver shortage due to the massive request of liver transplantation. About 10,000 persons in the US alone are on a waiting list for a liver transplant, causing a wait of up to 5 years, during which some patients will die being receiving a transplant. With the massive request for liver transplantation, challenges and difficulties come up with donor quality assessment, recipient selection, immunosuppression, and infectious complications. Monoethyl-glycinexylidide (MEGX) is a primary method to make a dynamic test of liver function for the transplantation. However, this test is invasive and always be affected by gender and other drugs in the donor. To further confirm the quality of donor livers, histopathology is the current gold-standard to assess the donor liver through evaluating the allograft diseases and other tissues for infections to provide the suitability of the donor liver for transplantation.

To better evaluate the marginal livers and expand the donor pool, current techniques include: 1) the pre-transplant liver biopsy and the associated histopathology (golden standard) is performed on the extended criteria donor. Moreover, 2) the magnetic resonance imaging proton density fat fraction (MRI-PDFF) has been reported to extract steatosis information for liver viability evaluation. 3) computed tomography (CT) has been demonstrated to detect liver volume, steatosis, and cirrhosis for liver quality assessment. However, MRI-PDFF and CT have the limitations of low-resolution and low-accuracy for the imaging of hepatic microstructures (steatosis). MRI is associated with high costs, while CT poses safety concerns. Additionally, MRI and CT cannot provide enough information about liver tissues such as fibrosis. Pre-transplant liver biopsy and the associated histopathology is the current clinical standard. Nonetheless, biopsy is invasive and the single tissue slicing limits a comprehensive evaluation of the entire donor liver.

Unfortunately, due to the invasiveness and limited sampling volume of the biopsy, studies have shown controversies in the utility of procurement biopsies for evaluating donor livers. Therefore, there is a critical need to explore new noninvasive ways to predict transplant liver viability through.

### BRIEF DESCRIPTION OF DRAWINGS

The patent or application file contains at least one drawing executed in color. Copies of this patent or patent application publication with color drawings will be provided by the Office upon request and payment of the necessary fec.

The following drawings form part of the present specification and are included to further demonstrate certain aspects of the present invention. The invention may be better understood by reference to one or more of these drawings in combination with the detailed description of specific embodiments presented herein.

FIG. 1 depicts an exemplary system diagram of a pre-transplantation evaluation of human liver using polarization-sensitive optical coherence tomography.

FIGS. 2A-I depicts the framework of hepatic heterogeneity characterization and imaging parameters correlation between histopathology and PS-OCT based on deceased donor livers.

FIG. 3 depicts an exemplary flow chart depicting an exemplary pre-transplantation evaluation method using polarization-sensitive optical coherence tomography.

FIGS. 4A-E depict distribution characters of hepatic histopathology on the entire donor liver

FIGS. 5A-G depict segmentation and quantification of hepatic steatosis from PS-OCT intensity images for viability evaluation.

FIGS. 6A-6F depicts recognition and quantification of hepatic fibrosis from PS-OCT DOPU images for viability evaluation.

FIGS. 7A-I depict extraction and quantification of hepatic inflammation by texture features from PS-OCT intensity images.

FIGS. 8A-8I depict extraction and quantification of hepatic necrosis by texture features from PS-OCT intensity images.

FIGS. 9A-9C depicts the comprehensive assessment of donor liver viability with hepatic steatosis, fibrosis, inflammation, and necrosis by PS-OCT imaging.

FIGS. 10A-10L the flow diagram of mapping the virtual 3D distribution characters over the entire liver from PS-OCT and biopsy scores.

FIG. 11 depicts the evaluation and performance of machine learning models in hepatic inflammation classification and texture feature distribution based on PS-OCT intensity images.

FIG. 12 depicts the evaluation and performance of machine learning models in hepatic necrosis classification and texture feature distribution based on PS-OCT intensity images.

FIG. 13 depicts the system schematic of polarization-sensitive optical coherence tomography (PS-OCT) for liver imaging.

FIG. 14 depicts a flow chart and diagram of PS-OCT intensity image filtering by a Pix2Pix U-Net model

FIG. 15 depicts a flow diagram of the automatic segmentation of hepatic steatosis from PS-OCT intensity images by automatic threshold segmentation method.

FIG. 16 depicts a comparison of the segmentation accuracy for the automatic segmentation of hepatic steatosis between the Sauvola Auto-Threshold and manual raters.

FIG. 17 depicts a flow chart of the texture feature extraction of PS-OCT intensity images and the screening of effective texture feature.

FIG. 18 depicts a comparison of hepatic inflammation classification accuracy from the k-nearest neighbor (kNN) learning model by different feature inputs

FIG. 19 depicts a histopathological assessment is made during which tests on portions of a single biopsied sample of the liver are conducted.

FIG. 20 depicts an exemplary evaluation if the liver meets a predetermined acceptable score, the liver is considered to be suitable for transplantation into a recipient

FIG. 21 depicts an exemplary score table for steatosis, inflammation fibrosis, and necrosis.

FIG. 22 depicts multiple locations on the liver surface that were labeled.

FIG. 23 depicts liver scans of the liver indicating that the distribution of steatosis is heterogeneous on the entire liver surface.

FIG. 24 depicts training involving deep learning models to recognize steatosis.

FIG. 25 depicts an exemplary histogram of roughness in relation to a discrete wavelet transform DWT, gray level size zone matrix GLSZM, and gray-level co-occurrence matrix GLCM.

FIG. 26 depicts PS-OCT DOPU scores used in a linear fitting used to correlate the DOPU and Histology scores.

FIG. 27 depicts an exemplary DOPU scoring based on DOPU and threshold values.

FIG. 28 depicts variation in intensity levels revealed variations in microstructure at different locations.

FIG. 29 depicts variation in intensity levels revealed variations in microstructure at different locations.

FIG. 30 depicts variation in intensity levels revealed variations in microstructure at different locations.

FIG. 31 depicts an exemplary PS-OCT was able to distinguish liver tissues with/without steatosis. and was able to locate steatosis droplet structures.

FIG. 32 an exemplary PS-OCT model that was able to locate steatosis droplet structures

FIG. 33 depicts training involving deep learning models to recognize steatosis.

FIG. 34 depicts finding the feature value of steatosis of <33% and >33%, then set the threshold using the average of feature values to separate.

FIG. 35 depicts finding the feature value of steatosis <33% and >33%, then set the threshold using the average of feature values to separate.

### DETAILED DESCRIPTION

Apparatus and associated methods relate to a pre-transplantation evaluation of human livers using optical coherence tomography. In an illustrative example, a computer-implemented method performed by at least one processor to conduct a non-invasive evaluation of a liver prior to a transplantation procedure the method including: providing a polarization-sensitive optical coherence tomography (PS-OCT) system, wherein the PS-OCT system is coupled to a machine-learning-based system trained to evaluate PC-OCT images of liver; using the PC-OCT system to provide a set of intensity and polarization images obtained from a plurality of sites on the liver to identify hepatic microstructures related to steatosis, fibrosis, inflammation, and necrosis in the liver; determining steatosis, fibrosis, inflammation, and necrosis scores for the liver; determining whether the liver is suitable for use as a donor liver when the steatosis, fibrosis, inflammation, and necrosis scores meet predetermined donor suitability criteria; determining whether the liver is unsuitable for use as a donor liver when the steatosis, fibrosis, inflammation, and necrosis scores fail to meet predetermined donor suitability criteria; and, maintaining the liver under proper preservation conditions when the liver is determined to be suitable for use as a donor liver.

Some embodiments of the PS-OCT system further may, for example, include a broadband light source having a center wavelength of 1300 nm and configured to emit linear-polarized light.

Some embodiments of the PS-OCT system may, for example, include a polarization controller optically coupled to the broadband light source configured to adjust the polarization state of the emitted light.

Some embodiments of the PS-OCT system may, for example, include a polarizer optically coupled to the polarization controller to ensure a defined linear polarization state.

Some embodiments of the PS-OCT system further may, for example, include a circulator optically coupled to the polarizer to direct light flow.

Some embodiments of the PS-OCT system may, for example, include a fiber-to-free space collimator optically coupled to the circulator to transition light from fiber to free space.

Some embodiments of the PS-OCT system further may, for example, include a beam splitter optically couple dot the fiber-to free-space collimator, configured such that the beam splitter divides the light into sample arm and a reference arm.

Some embodiments of the PS-OCT system may, for example, be configured such that the the sample arm includes an adjustable iris to control the beam size and a first quarter-wave plate oriented at a predetermined angle to modify the polarization state of light.

Some embodiments of the PS-OCT system may, for example, be configured such that the predetermined angle to modify the polarization state of light is 22.5 degrees.

Some embodiments of the PS-OCT system further may, for example, be configured such that the sample arm further comprises a second quarter-wave (QWP 2) oriented at 45 degrees to further manipulate the polarization state; a galvo mirror to steer the light beam; and, an predetermined instruction configured to focus the light onto a sample, wherein the sample arm is configured to produce circularly polarized incident light on the sample arm with equal amplitude in both orthogonal polarizations.

Some embodiments of the PS-OCT system further may, for example, be configured to include a mirror configured to reflect the light back to the beam splitter, configured to enable interference with light from the sample arm; and, the interfered light is directed back through the beam splitter and fiber-to-free space collimator to the circulator.

Some embodiments of the PS-OCT system further may, for example, further include a polarization-sensitive beam splitter optically coupled to receive interfered light from the circulator by the fiber-to-free-space collimator; and, a first channel sensor and a second channel sensor optically coupled to polarization-sensitive beam splitter to detect intensity and polarization information from the sample.

Some embodiments may, for example, further include the addition of preparing the liver with multiple position labeling to create a set of labeled positions.

Some embodiments may, for example, further include the step of PS-OCT scanning each labeled position.

Some embodiments may, for example, include transplanting the liver into a transplant recipient when the liver is determined to be suitable for use as a donor liver.

Some embodiments may, for example, include a method of storing a liver for a transplantation procedure, including: providing a deceased donor liver, wherein the deceased donor liver is stored in a storage apparatus for preserving the liver prior to the transplantation procedure; providing a polarization-sensitive optical coherence tomography (PS-OCT) system, wherein the PS-OCT system is coupled to a machine-learning-based system trained to evaluate PC-OCT images of liver; using the PC-OCT system to provide a set of intensity and polarization images obtained from a plurality of sites on the liver to identify hepatic microstructures related to steatosis, fibrosis, inflammation, and necrosis in the liver; determining steatosis, fibrosis, inflammation, and necrosis scores for the liver; and returning the deceased donor liver to the storage apparatus for continued preservation prior to the transplantation procedure.

Some embodiments may, for example, include a system including: a data store comprising a program of instructions; and a processor operably coupled to the data store such that, when the processor executes the programs of instructions, the processor operations to be performed to conduct a non-invasive evaluation of a liver prior to a transplantation procedure, the method including: providing a polarization-sensitive optical coherence tomography (PS-OCT) system, wherein the PS-OCT system is coupled to a machine-learning-based system trained to evaluate PC-OCT images of liver; using the PC-OCT system to provide a set of intensity and polarization images obtained from a plurality of sites on the liver to identify hepatic microstructures related to steatosis, fibrosis, inflammation, and necrosis in the liver; determining steatosis, fibrosis, inflammation, and necrosis scores for the liver; determining whether the liver is suitable for use as a donor liver when the steatosis, fibrosis, inflammation, and necrosis scores meet predetermined donor suitability criteria; determining whether the liver is unsuitable for use as a donor liver when the steatosis, fibrosis, inflammation, and necrosis scores fail to meet predetermined donor suitability criteria; and, maintaining the liver under proper preservation conditions when the liver is determined to be suitable for use as a donor liver; wherein the PS-OCT system further comprises: a broadband light source and configured to emit linear-polarized light; a polarization controller optically coupled to the broad band light source configured to adjust the polarization state of the emitted light; a polarizer optically coupled to the polarization controller to ensure a defined linear polarization state; and, a circulator optically coupled to the polarizer to direct light flow.

Liver transplantation is the most effective treatment of hepatic diseases, but current evaluation of pre-transplantation faces challenges. Optical coherence tomography (OCT) and novel imaging processing techniques effectively provide a comprehensive and noninvasive evaluation of pre-transplantation viability throughout the entire donor liver by quantitatively evaluating liver microstructures and tissue distributions.

The disclosed technology includes an innovative medical device that integrates a noninvasive imaging modality with high-speed capabilities. It offers comprehensive evaluation accuracy and employs artificial intelligence to predict post-transplantation outcomes and enhance liver viability assessment in real-time.

The novel technology includes several key advancements over the current standard of care. First, the device is portable and user-friendly, allowing surgeons to operate it with minimal training in the operating room, thereby saving significant evaluation time compared to traditional pathology methods. Second, the disclosed system employs noninvasive and noncontact scanning with high speed and high resolution in real-time, providing an optical virtual biopsy without causing any damage to donor livers. Third, the ability to scan multiple regions of the liver offers a more comprehensive and reliable transplant viability evaluation for marginal donor livers, addressing the current clinical evaluation bias of examining only a single hepatic tissue sample via pathology. Fourth, the integration of artificial intelligence models will enable reliable predictions of graft function and outcomes, assisting doctors and surgeons in preventing postoperative complications and reducing the risk of immune rejection. Compared to the conventional single-sample biopsy method, the disclosed technology is able to noninvasively provide microstructure information and tissue distribution characteristics throughout the entire liver to offer a comprehensive evaluation of pre-transplantation livers.

The technology therefore provides a crucial clinical tool for assessing transplant viability and predicting graft outcomes of deceased marginal donor livers, aiming to screen reliable marginal donor livers and predict postoperative complications in liver transplant recipients. Targeting organ procurement centers and hospitals, the presently disclosed approach offers comprehensive viability evaluations to select suitable marginal donor livers and supports hospitals in managing transplant outcomes effectively.

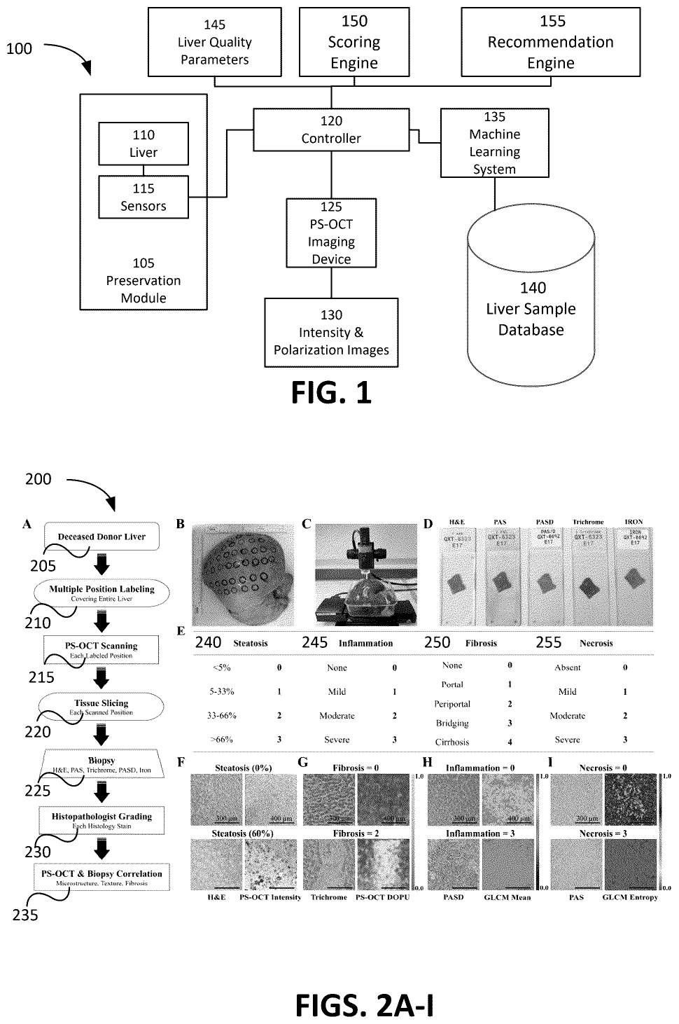

FIG. 1 depicts an exemplary system diagram 100 of a pre-transplantation evaluation of human liver using polarization-sensitive optical coherence tomography. The system diagram 100 includes a preservation module 105. Preservation module 105 is being used to evaluate a liver 110. Preservation module 105 includes sensors 115. Sensors 115 commutatively couples to a controller 120. Controller 120 may, for example, include at least at one processor. Controller 120 commutatively couples to a PS-OCT imaging device 125. PS-OCT imaging device 125 is used to take intensity and polarization images 130. Controller 120 is commutatively coupled to a machine learning system 135. Machine learning system 135 is being used to compare intensity and polarization images 130 with a liver sample database 140.

Controller 120 utilizes a liver quality parameters 145. Liver quality parameters 145 may, for example, be used in connection with machine learning system 135 and intensity and polarization images 130 to evaluate steatosis. Liver quality parameters may, for example, be used in connection with machine learning system 135 and intensity and polarization images 130 to evaluate fibrosis. Liver quality parameters 145 may, for example, be used in connection with machine learning systems 135 and intensity and polarization images 130 to evaluate inflammation. Liver quality parameters 145 may, for example, be used in connection with machine learning system 135 and intensity and polarization images 130 to evaluate necrosis.

Controller 120 utilizes a scoring engine 150. Scoring engine 150 may, for example, be used in connection with machine learning system 135 and intensity and polarization images 130 to score steatosis. Scoring engine 150 may, for example, be used in connection with machine learning system 135 and intensity and polarization images 130 to score fibrosis. Scoring engine 150 may, for example, be used in connection with machine learning system 135 and intensity and polarization images 130 to score inflammation. Scoring engine 150 may, for example, be used in connection with machine learning system 155 and intensity and polarization images 130 to score necrosis.

Controller 120 utilizes recommendation engine 155. Recommendation engine in connection with machine learning system 135 and intensity and polarization images may, for example, recommend whether liver 110 is viable for organ transplant based on the scoring engine. Recommendation engine 155 in connection with machine learning system 135 and intensity and polarization images may, for example, recommend whether if liver 110 is not viable for organ transplant based on the scoring engine.

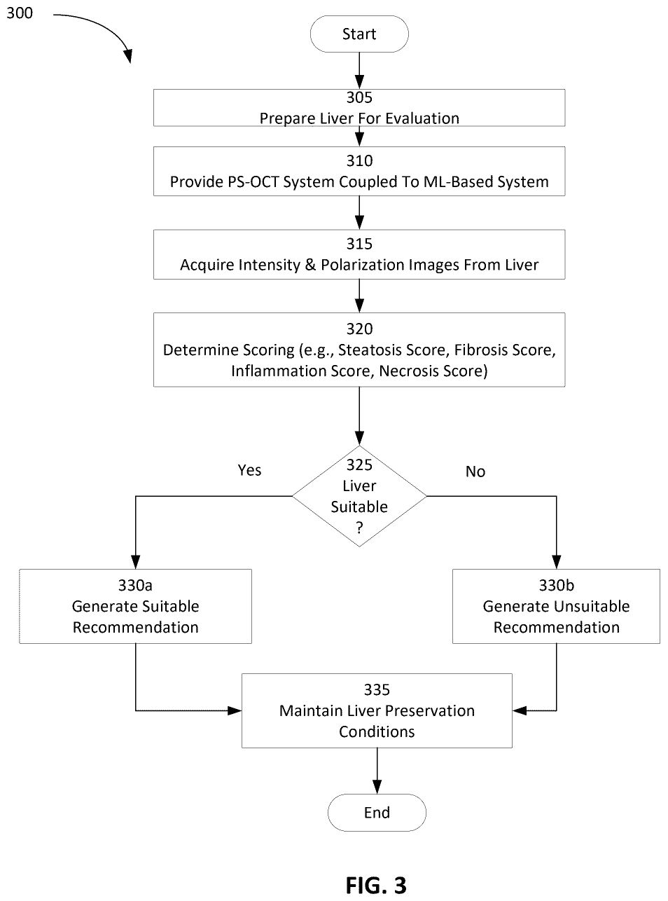

FIG. 3 depicts an exemplary flow chart 300 depicting an exemplary pre-transplantation evaluation method using polarization-sensitive optical coherence tomography. The user of the method may, for example, include controller 120. Controller 120 may, for example, include at least one computer processor. In step 305, the user of the method prepares a liver for evaluation. In step 310, the user provides a PS-OCT System coupled to a machine learning-based system. In step 315, the user acquires an intensity and polarization image from liver. In step 320, a user determines scoring of the liver. The scoring may, for example, include a steatosis score, fibrosis score, inflammation score, and necrosis score. In step 325, the user of the method determines whether the liver is suitable based on the scoring. In step 330a, if the liver is suitable based on the scoring the user of the method generates a suitable recommendation that the liver is suitable for transplant is generated. In step 330b, if the liver is not suitable based on the scoring the user of the method generates a not suitable recommendation that the liver is not suitable for transplant is generated. In step 335, a user of the method maintains a liver preservation conditions as the liver is transplanted for transplant if suitable.

### I. Definitions

As used herein the specification, “a” or “an” may mean one or more. As used herein in the claim(s), when used in conjunction with the word “comprising,” the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Throughout this application, the term “about” is used to indicate that a value includes the inherent variation of error for the device, the inherent variation in the method being employed to determine the value, the variation that exists among the study subjects, or a value that is within 10% of a stated value.

### II. Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1—Evaluation of Human Donor Liver Viability with Polarization-Sensitive Optical Coherence Tomography

Human liver transplantation is severely constrained by a critical shortage of donor livers, with approximately one quarter of patients on the waiting list dying due to the scarcity of viable organs. Current liver viability assessments, which rely on invasive pathological methods, are hampered by limited sampling from biopsies, particularly in marginal livers from extended criteria donors (ECD) intended to expand the donor pool. Consequently, there is a pressing need for more comprehensive and non-invasive evaluation techniques to meet the escalating demand for liver transplants. In this study, we propose the use of polarization-sensitive optical coherence tomography (PS-OCT) to perform a thorough viability evaluation across the entire surface of donor livers. PS-OCT imaging was conducted on multiple regions, achieving near-complete coverage of the liver surface, and the findings were cross-validated with histopathological evaluations. The analysis of hepatic parameters derived from pathology highlighted tissue heterogeneity. Leveraging machine learning and texture analysis, we quantified hepatic steatosis, fibrosis, inflammation, and necrosis, and established strong correlations (≥80%) between PS-OCT quantifications and pathological assessments. PS-OCT offers a non-invasive assessment of liver viability by quantifying hepatic parenchymal parameters across the entire donor liver, significantly complementing current pathological analysis. These results suggest that PS-OCT provides a robust, non-invasive approach to assessing donor liver viability, which could potentially decrease the discard rate of higher risk livers, thereby expanding the donor pool and reducing the inadvertent use of those livers unsuitable for transplantation.

Liver transplantation (LT) is the only viable therapy for patients experiencing extremely severe liver diseases such as cirrhosis and carcinomas at an advanced stage. The demand for liver transplants has grown significantly in recent decades, and more than 10,000 candidates were waiting for liver allografts in 2023 in the US (with over 10,000 performed liver transplants). A shortage of donor livers remains a major limitation and accounts for a large proportion of waitlist mortality. With the increasing number of waitlisted candidates and the rising number of patients dying while waiting (1 of 4 patients died on the liver waiting list in the US in 2023), efforts have been made in recent decades to increase the utilization of so-called marginal donor livers; such as livers from donors with advanced age, steatosis, ischemia, and hepatitis C virus-positive infection. However, the current standard methods for screening marginal livers fail to provide transplant surgeons with sufficient information to make informed decisions, leading to a discard rate of nearly 70-80% for these types of donor livers. Liver donor risk index (LDRI) is used to inform the viability of donor livers via evaluating independent donor characteristics such as age, cause of death, and split/partial allografts, but over 70% of physicians believe LDRI inadequately predicts the risk of organ failure or primary nonfunction, leading to persistently high discard rates.

Pretransplant liver biopsy is the current gold standard for assessing these conditions in donor livers. Hepatic steatosis, fibrosis, inflammation, and necrosis are four key parameters for evaluating donor liver viability from the biopsied tissue, with steatosis being the most dominant. Steatosis, often induced by nonalcoholic fatty liver disease, is highly prevalent in donor livers and can impact transplantation outcomes by increasing cold ischemic injury and impairing hepatic regeneration. It is associated with early allograft dysfunction, primary nonfunction, and postreperfusion syndrome. Additionally, elevated levels of fibrosis, inflammation, and necrosis correlate with increased graft dysfunction, reduced bile production, and impaired metabolic function, impacting both pre-transplantation evaluation and post-transplantation outcomes.

For the biopsied liver tissue, Hematoxylin & Eosin (H&E) staining is routinely performed for histopathological assessment of liver quality. Additionally, stains like Periodic acid-Schiff (PAS), Trichrome, Periodic acid-Schiff-diastase (PASD), and Prussian Blue Iron are essential for evaluating steatosis, fibrosis, inflammation, and necrosis in donor livers. To minimize damage to the liver, only one or two tissue samples are taken from the liver during the biopsy in current clinical practice. Therefore, liver biopsy is invasive but suffers from a significant risk of sampling errors, limiting the utility of biopsy. Liver biopsy analysis evaluates only one or 2 tiny fractions of the organ, providing an incomplete assessment of liver viability that does not adequately address the concerns transplant surgeons have about the condition of organs, especially those from deceased donors. An even worse scenario is that some high-risk livers get transplanted due to favorable biopsy findings in the tiny fraction of the liver evaluated. Therefore, there is a critical need for a technique that can achieve noninvasive evaluation of the entire liver to help determine graft viability.

Optical coherence tomography (OCT) is a noninvasive, label-free, high-speed imaging technique for depth-resolved imaging in real time. At present, OCT is widely employed for providing structural imaging in diverse domains, encompassing the examination of the human retina, cancerous tissues, various organs, vasculature, and applications within the field of dentistry. Specifically, OCT has demonstrated significant potential in characterizing microstructures of human organs, including kidney tubules and glomeruli, as well as liver portal tracts. Moreover, OCT has undergone extensive development to yield enhanced tissue and functional information, including the imaging of fibrosis or collagen through polarization-sensitive OCT (PS-OCT). Despite these advances, no OCT studies have yet been conducted to establish quantitative assessment criteria for the viability of pre-transplant livers. The integration of structural and functional information through PS-OCT provides a novel approach to bridging the gap between research and clinical application in the pre-transplantation assessment of livers.

In this study, we first quantitatively evaluated the heterogeneity of hepatic tissue on deceased donor livers. After that, we systematically investigated the potential of PS-OCT for comprehensive imaging of deceased donor livers in a non-invasive and near real-time fashion. We utilized PS-OCT intensity and polarization images to correlate with liver biopsies in hepatic steatosis, fibrosis, inflammation, and necrosis with the assistance of structural tissue features and machine learning to build evaluation criteria for donor livers. After correlating assessment parameters and establishing screening thresholds for pathologically confirmed cases, we conducted a double-blind cross-test to evaluate the accuracy of PS-OCT. Our results introduce a noninvasive imaging method for generating a near real-time, color-coded viability map of the entire donor liver, thereby offering a comprehensive visualization and evaluation method to determine organ suitability for transplantation. This work highlights the translational potential and feasibility of PS-OCT in pre-transplantation donor liver evaluation.

FIGS. 2A-I depicts a framework 200 of hepatic heterogeneity characterization and imaging parameters correlation between histopathology and PS-OCT based on deceased donor livers. Framework 200 examines the feasibility of PS-OCT for the pre-transplant assessment of deceased donor livers, as illustrated in FIGS. 2A-2I.

FIG. 2A depicts the flow chart of PS-OCT scanning and hepatic biopsy of the entire donor liver. In step 205, a deceased donor liver is donated. In step 210, multiple position labeling are applied to the donor level. The labeling may, for example, cover the entire of the liver. In step 215, PS-OCT scanning is conducted on each labeled position. In step 220, tissue slicing is conducted on each scanned position. In step 225, biopsy is conducted to determine scoring of H&E, PAS, trichrome, PASD, and Iron. In step 230, a histopathologist grading is conducted. In step 235, a PS-OCT & Biopsy Correlation based on factors of microstructure, texture, and fibrosis.

The procedural overview, delineated in FIG. 2A, encompasses the PS-OCT scanning process and the comprehensive hepatic biopsy examination conducted across the entire liver. Deceased donor livers were obtained from LifeShare of Oklahoma, a non-profit Organ Procurement Organization (OPO) exclusively dedicated to organ and tissue retrieval for transplantation purposes.

FIG. 2B depicts a representative deceased donor liver labeled with 40 imaging sites (dark circles). Manual labeling with medical ink at 20-40 locations covered the entirety of the liver surface, as illustrated in FIG. 2B.

FIG. 2C depicts the schematic of PS-OCT liver scanning. Subsequently, a customized PS-OCT system scanned each labeled position to acquire intensity and polarization images, facilitating the quantification of microstructures and tissue properties, as demonstrated in FIG. 2C.

FIG. 2D depicts a representative biopsy of hepatic tissues from a labeled region. After imaging, hepatic tissue sections from each labeled position underwent histological staining, including H&E, PAS, Trichrome, PASD, and Iron stains, for the viability assessment of hepatic tissues (FIG. 2D).

FIG. 2E depicts the score sheet of grading liver biopsies. Employing established histopathologic criteria, three board-certified pathologists utilized a scoring sheet based on prevailing clinical evaluation standards (Banff Criteria) to grade the donor liver histopathological features. (FIG. 2E).

Scoring steatosis criteria 240 is provided. A score less than 5% steatosis is given score of 0. A score between 5% to 33% is given a score of 1. A score between 33% to 66% is given a score of 2. A score greater than 66% is a score of 3.

Scoring inflammation criteria 245 is provided. No inflammation is given a score of 0. Mild inflammation is given a score of 1. Moderate inflammation is given a score of 2. Sever inflammation is given a score of 3.

Scoring fibrosis 250 is provided. A sample depicting no fibrosis is given a score of 0. A sample depicting portal is given a score of 1. A sample depicting periportal is given a score of 2. A sample depicting bridging is given a score of 3. A sample depicting cirrhosis is given a score of 4.

Scoring steatosis criteria 255 is provided. A sample having necrosis absent is given a 0 score. A sample having mild necrosis is given a 1 score. A sample having moderate necrosis is given a 2 score. A sample having severe necrosis is given a 3 score.

FIG. 2F depicts a representative H&E stains and PS-OCT intensity images of different degrees of steatosis. To assess the correlation between PS-OCT and biopsy results, total steatosis was extracted from PS-OCT intensity images to align with histological data (FIG. 2F).

FIG. 2G depicts a representative Trichrome stain and DOPU images of different degrees of fibrosis. Fibrosis quantification from PS-OCTDegree of Polarization Uniformity (DOPU) images was correlated with biopsy findings (FIG. 2G).

FIG. 2H depicts representative PASD stains and PS-OCT texture images of different degrees of inflammation. Additionally, texture features from PS-OCT intensity images were extracted for integration into machine learning models, aligning with the evaluation of inflammation performance from histological stains.

FIG. 2I depicts representative PAS stains and PS-OCT texture images of different degrees of necrosis. Additionally, texture features from PS-OCT intensity images were extracted for integration into machine learning models, aligning with the evaluation of necrosis performance from histological stains.

Through the mapping of hepatic steatosis, fibrosis, inflammation, and necrosis from both biopsy and PS-OCT, we quantified the correlation between these modalities by assessing matching accuracy across the entire liver.

We used the Student's t-test for comparing differences. A paired t-test was conducted to evaluate the correlation between biopsy results and PS-OCT measurements. An unpaired t-test was used to compare effective features across different scores and risk categories derived from PS-OCT texture feature extraction. A P-value of <0.05 indicates a significant difference, while a P-value of ≥0.05 indicates that the difference is not significant. The correlation rates are calculated based on the true low-risk (TL), true high-risk (TH), false low-risk (FL), and false high-risk (FH). Specifically, the correlation accuracy, sensitivity, and specificity are obtained by:

$$Accuracy = \frac{TL + TH}{TL + FL + TH + FH}$$

$$Sensitivity = \frac{TL}{TL + FH}$$

$$Specificity = \frac{TH}{TH + FL}$$

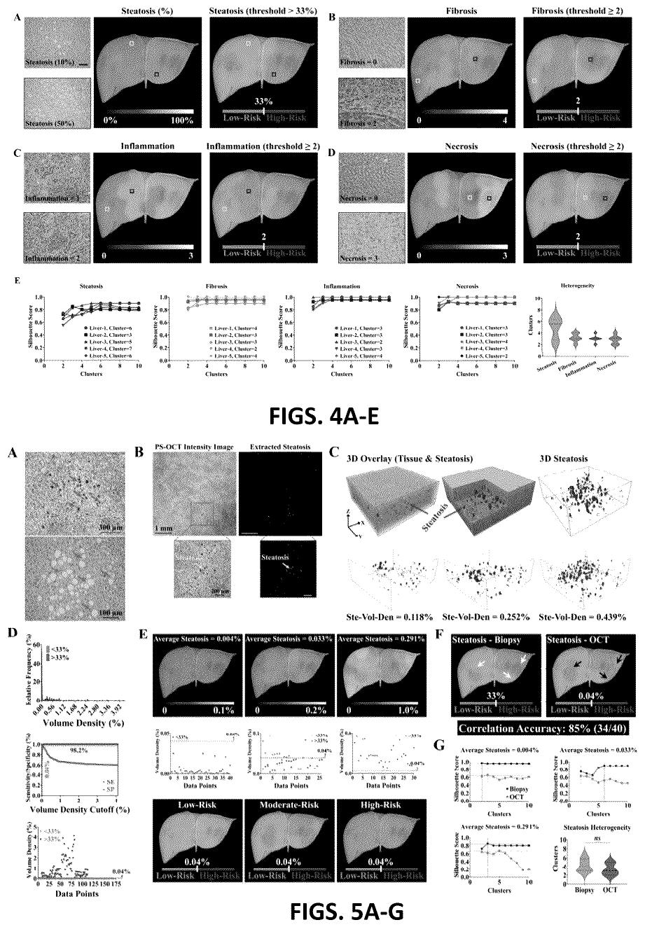

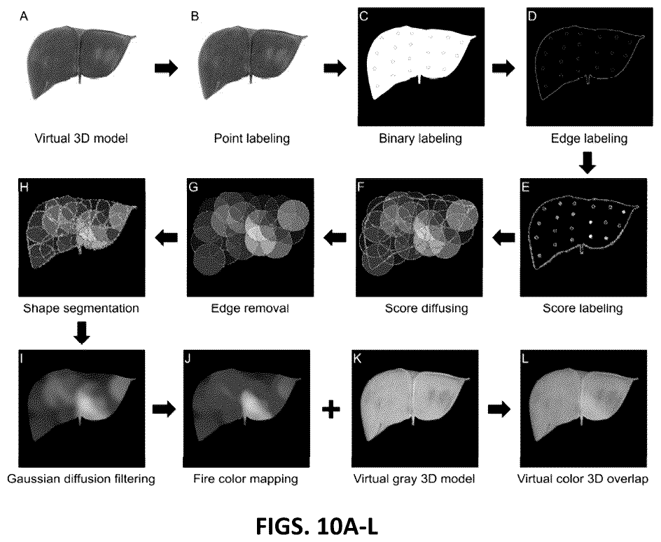

FIGS. 4A-E depict distribution characters of hepatic histopathology on the entire donor liver. We systematically mapped the distribution patterns of four key clinical histopathologic parameters—steatosis, fibrosis, inflammation, and necrosis across the entire donor liver. The liver was sectioned into 20-40 regions to comprehensively cover its surface. FIG. 4 illustrates the heterogeneous distribution of these parameters on the liver surface. Score mapping was performed over the entire liver surface using point Gaussian diffusion filtering, overlaying the scores on a virtual 3D liver model. The detailed reconstruction process of this virtual 3D score mapping is described in FIG. 10A-10L. The quantification of the histopathologic parameters and the assessment of donor liver suitability were based on selected sectioning regions. A widely adopted clinical standard for determining the low-risk or high-risk of donor livers based on pathology (Table 1) was applied to map the distribution of hepatic tissues throughout the donor liver.

TABLE 1
Selected Low-risk and High-risk Criteria for Liver Transplantation
Based on Clinical Frozen Section Pathology

| Parameter | Low-Risk Criteria | High-Risk Criteria |
|---|---|---|
| Steatosis (macrovesicular | ≤33% hepatocytes involved | >33% hepatocytes involved |
| steatosis) | (score 0, 1) | (score 2, 3) |
| Fibrosis | Stage < 2 (score 0, 1) | Stage > 2 (score 2, 3, 4) |
| Portal Tract Inflammation | ≤Mild (score 0, 1) | >Mild (score 2, 3) |
| Necrosis | ≤4 necrotic foci (score 0, 1) | >4 necrotic foci (score 2, 3) |

Our results demonstrated a high degree of regional heterogeneity in degrees of steatosis (FIG. 4A), fibrosis (FIG. 4B), and necrosis (FIG. 4D), with the coexistence of mild steatosis (10%), non-fibrous (0), and non-necrotic (0) tissues alongside regions exhibiting extreme steatosis (50%), fibrosis (score 3), and necrosis (score 3) within the same donor liver. Inflamed hepatic tissues showed a gradual gradient of heterogeneity (scores 1 and 2) throughout the liver. Quantitative evaluation also revealed significant regional variability in inflammation (FIG. 4C), a crucial factor for assessing donor liver viability according to current clinical standards. H&E, Trichrome, and PAS biopsies highlighted varying degrees of hepatic steatosis, fibrosis, inflammation, and necrosis within representative samples from the same donor liver.

In FIG. 4E, a K-means unsupervised learning model was used to evaluate the heterogeneity degree of these four pathological parameters through clustering and silhouette analysis. The optimal number of clusters was determined by the highest silhouette scores, with higher cluster numbers indicating greater heterogeneity. Steatosis, fibrosis, inflammation, and necrosis exhibited multiple cluster distributions across the liver surface in five representative livers, highlighting the heterogeneity of these pathologic parameters across the organ. Among these parameters, steatosis demonstrated the greatest heterogeneity across the liver surface, due to its substantially higher clustering compared to fibrosis, inflammation, and necrosis.

FIGS. 5A-G depict segmentation and quantification of hepatic steatosis from PS-OCT intensity images for viability evaluation. PS-OCT provided intensity and polarization images (including phase retardation, optic axis, and DOPU) to qualitatively and quantitatively assess hepatic microstructures. Our results showed that PS-OCT intensity images revealed distinct microstructural characteristics across various sites, highlighting the heterogeneity of hepatic tissue microstructures over the liver surface. Notably, PS-OCT intensity images enabled the direct detection of regions of steatosis, and these findings were confirmed by histologic evaluation (FIG. 5A). Steatosis was automatically segmented and extracted from PS-OCT intensity images (FIG. 5B), with red and blue frames indicating the enlarged steatosis structures before and after segmentation, respectively.

FIC. 5C depicts a 3D reconstruction of steatosis within hepatic tissues, providing insights into its spatial distribution and allowing quantification of volumetric density (green frames). To establish a threshold for classifying steatosis density as low-risk or high-risk based on pathology, we plotted a histogram of steatosis volume density (%) (FIG. 5D). From the training dataset, an optimal threshold of 0.04% was identified, achieving a sensitivity of 0.98 and specificity of 0.97 in correlating PS-OCT evaluations with pathology. The scatter plot indicated that a steatosis density threshold of 0.04% effectively distinguished between low-risk (<33%) and high-risk (>33%) hepatic tissues. FIG. 5E presents three representative livers with low (0.004%), medium (0.033%), and high (0.291%) average steatosis densities, mapping the spatial distribution of steatosis over the liver surface. These PS-OCT images revealed a heterogeneous distribution of steatosis across the entire liver surface, validating concerns that tissue biopsy may be subject to significant sampling error. The scatter plots further classify steatosis density using the 0.04% PS-OCT threshold and compare it to pathology-based steatosis density.

For the liver with a low average steatosis density score, all scanned regions were classified as low-risk according to both the PS-OCT threshold of 0.04% and the pathology threshold of 33%, categorizing it as a low-risk donor liver. In contrast, the liver with a high average steatosis density score was uniformly classified as high-risk under both thresholds. The representative liver with a medium average steatosis density score contained both low-risk and high-risk regions based on PS-OCT and pathology thresholds, requiring further evaluation for a final risk assessment as moderate-risk. Using a steatosis density threshold of 0.04% for PS-OCT and 33% for pathology, we compared classifications across the liver surface, achieving a high correlation accuracy of 85% (34 out of 40 sites) (FIG. 5F).

In FIG. 5G, we observed different clustering distributions of steatosis density scores between PS-OCT and pathology. Donor livers classified as low-risk or high-risk had a higher number of clusters in PS-OCT (magenta+cyan lines) than in pathology (red+blue lines), while donor livers classified as moderate-risk showed fewer clusters in PS-OCT. Statistical analysis indicated that despite differences in clustering numbers, the variation between PS-OCT and pathology was not statistically significant.

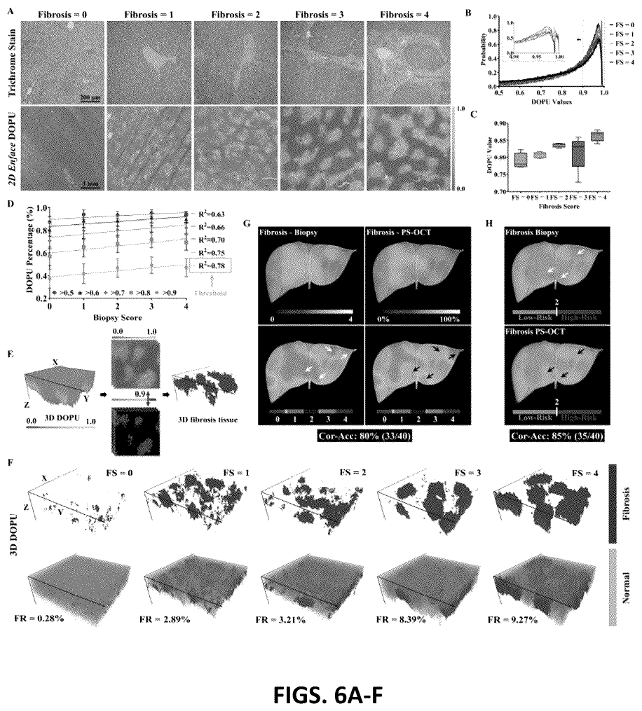

FIGS. 6A-6F depicts recognition and quantification of hepatic fibrosis from PS-OCT DOPU images for viability evaluation. Hepatic fibrosis is graded on a clinical scale from 0 to 4 to evaluate donor liver viability. FIG. 6A provides pathology images of hepatic tissues at different fibrosis levels, along with representative 2D DOPU images, to illustrate the recognition of fibrosis at varying levels. We observed that PS-OCT DOPU images effectively visualized and classified fibrosis grades as determined by pathology. FIG. 6B shows the DOPU value profiles for different fibrosis levels based on pathology from 6 donor livers, with an inset plot indicating that higher fibrosis levels correspond to higher DOPU values. A linear relationship was found between the average DOPU values and pathology scores, indicating that hepatic tissues with higher pathology scores have increased DOPU values (FIG. 6C).

To further correlate PS-OCT DOPU images with pathology scores, we performed a linear fitting to correlate DOPU percentages extracted using different thresholds with pathology scores. An optimal threshold of 0.9 was identified for fibrosis extraction from PS-OCT DOPU images, based on the highest R-square value of the linear fitting (FIG. 6D). Using this threshold, we extracted the 3D fibrosis structure from each PS-OCT DOPU dataset for quantification (FIG. 6E). Representative 3D fibrosis microstructures, corresponding to various pathology scores, and their calculated percentages within the 3D hepatic tissues are shown in FIG. 6F. These data indicate that tissues with higher fibrosis pathology scores exhibit more fibrosis as extracted from PS-OCT DOPU images.

In FIG. 6G, we present the distribution characteristics of fibrosis in a representative donor liver, mapped using both PS-OCT imaging and pathology. The top images depict the heterogeneous distribution of fibrosis as determined by DOPU and pathological quantification, while the bottom images show varying fibrosis levels based on DOPU and pathology scores. Our results revealed a strong correlation between PS-OCT DOPU imaging and pathology, with an 80% correlation accuracy across 33 out of 40 sites. However, discrepancies were noted in four specific regions of the liver surface, marked by white and black arrows. When applying current clinical standards to distinguish low-risk from high-risk regions, the correlation accuracy between PS-OCT and pathology were 85% (35 out of 40), as shown in FIG. 6H.

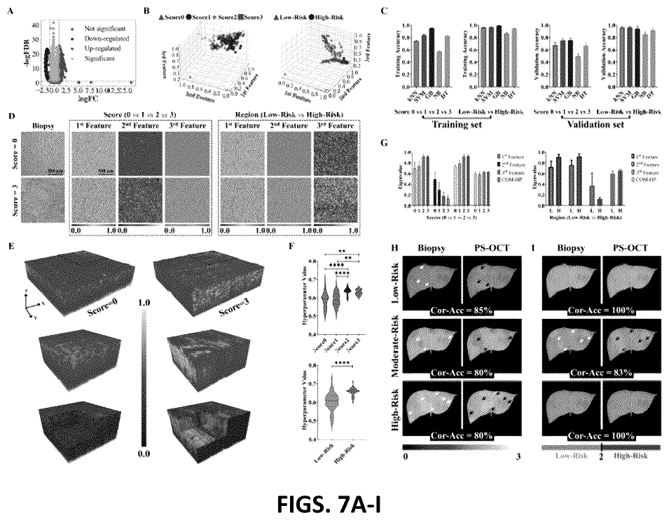

FIGS. 7A-I depict extraction and quantification of hepatic inflammation by texture features from PS-OCT intensity images. We extracted 2,484 texture features for each scanning site across the entire liver and compared these features at different pathologic inflammation scores using a volcano plot (FIG. 7A).

Most features showed significant differences across different inflammatory liver tissues, although the degree of difference was relatively low. Following feature selection using a random forest model, we obtained the spatial distribution of the top three most effective features for classifying specific inflammation scores and regions (FIG. 7B). These three effective features demonstrated spatial distribution differences when classifying varying inflammation scores and regions. The classification of inflammation regions, as opposed to specific scores, showed a higher level of significance in spatial distribution.

FIG. 7C presents a comparison of classification accuracy across different machine learning models, where the SVM model achieved the highest accuracy for both inflammation scores and regions.

In FIG. 7D, 2D PS-OCT texture feature images (specifically, the top three effective features) are compared with corresponding histology images at various inflammation scores, revealing notable differences in texture patterns and distributions. To visualize all effective texture features in inflammation classification in 3D, we reconstructed the 3D texture structure using composite hyperparameters, highlighting the spatial distribution of inflammation.

FIG. 7E illustrates that liver tissues without inflammation (score=0) and those with severe inflammation (score=3) exhibit substantial differences in spatial texture patterns and distributions, which correspond to histology findings in FIG. 7D.

FIG. 7F compares composite hyperparameters among different inflammation scores (0, 1, 2, 3) and between low-risk and high-risk regions. Significant differences were observed in composite hyperparameter values when comparing scores 0 vs. 2 (P<0.0001), 0 vs. 3 (P<0.01), 1 vs. 2 (P<0.0001), and 1 vs. 3 (P<0.01). Additionally, there was a significant difference between the composite hyperparameters of low-risk and high-risk regions (P<0.0001).

FIG. 7G show substantial differences and trends in the eigenvalues of the top three effective features and composite hyperparameters. Specifically, inflammation scores 0 and 1 are significantly different from scores 2 and 3. Moreover, the low-risk and high-risk regions exhibit significant differences based on the top three effective features and composite hyperparameters.

In FIG. 7H, we display the inflammation score distribution of three representative donor livers, comparing PS-OCT-imaging inflammation scores with corresponding biopsy scores. These livers are categorized as low-risk (scores 0, 1), moderate-risk (scores 1, 2), and high-risk (scores 2, 3) based on the biopsy inflammation scores over the entire liver. A strong correlation was observed between PS-OCT and biopsy results for hepatic inflammation score evaluation.

FIG. 7I compares the clinical standard (pathology) with the SVM-based texture feature standard in differentiating hepatic inflammation regions, where PS-OCT showed a stronger correlation with biopsy findings.

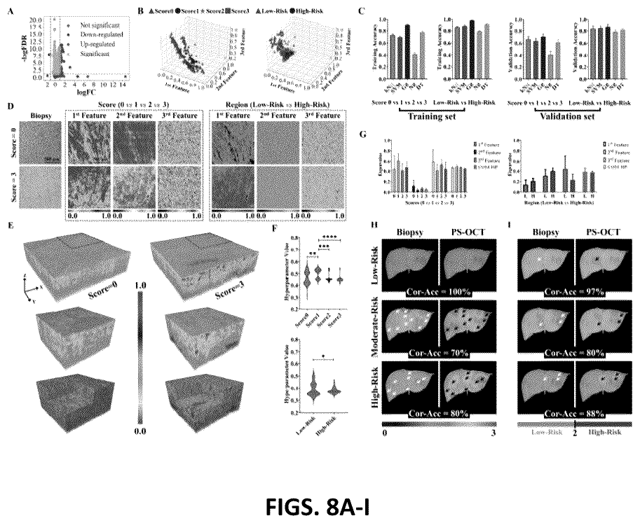

FIGS. 8A-8I depict extraction and quantification of hepatic necrosis by texture features from PS-OCT intensity images. We also extracted 2,484 texture features to compare and classify hepatic necrosis across specific biopsy scores and regions. As shown in FIG. 8A, most extracted texture features displayed significant differences in hepatic necrosis with specific scores, although the degree of difference was relatively low.

The top three most effective features, selected using a random forest model, were used to visualize the spatial distribution for classifying hepatic necrosis by specific scores and regions. Classification of necrotic regions showed greater significance than classification by necrosis scores (FIG. 8B).

FIG. 8C demonstrates that the Gradient Boosting (GB) model achieved the highest classification accuracy for hepatic necrosis, both at the level of specific scores and regions. The corresponding ROC-AUC and the distribution characteristics are based on the top two effective features. To assess the classification performance of hepatic necrosis from PS-OCT images, we compared images of the top effective feature with corresponding biopsy images (FIG. 8D). The texture feature images showed varying texture patterns and distributions according to different necrosis scores.

FIG. 8E presents the 3D reconstruction of hepatic necrosis based on composite hyperparameters, highlighting the differences between hepatic tissues without necrosis (score=0) and those with severe necrosis (score=3). We observed substantial differences in spatial texture patterns and distributions when examining the top three effective features and composite hyperparameters.

In FIG. 8F, the statistical characteristics of composite hyperparameter values are shown for specific necrosis scores and regions. Significant differences were found among the comparisons of scores 0 vs. 1 (P<0.01), 1 vs. 2 (P<0.001), and 1 vs. 3 (P<0.0001). Additionally, the composite hyperparameter distribution differed significantly between low-risk and high-risk regions.

To further explore texture differences and trends across necrosis scores and regions, we compared the eigenvalues of the top three effective features and composite hyperparameters. Our results indicate that hepatic necrosis in low-risk and high-risk regions shows substantial differences in texture features (FIG. 8G).

However, although significant differences were noted for specific necrosis scores, no clear trend emerged. We mapped the distribution of specific hepatic necrosis scores across three representative donor livers, comparing the correlations between PS-OCT findings and corresponding biopsy results (FIG. 8H).

These livers were categorized as low-risk (scores 0, 1), moderate-risk (scores 1, 2), and high-risk (scores 2, 3) based on pathological necrosis scores throughout the liver. A strong correlation between PS-OCT and biopsy results was observed for hepatic necrosis score evaluation in these livers.

Finally, in FIG. 8I, we compared the current clinical standard (biopsy) and the GB-based texture feature standard (PS-OCT) in distinguishing hepatic necrosis regions. We found that PS-OCT and biopsy demonstrated a stronger correlation in the evaluation of hepatic necrosis regions than in the evaluation of specific necrosis scores.

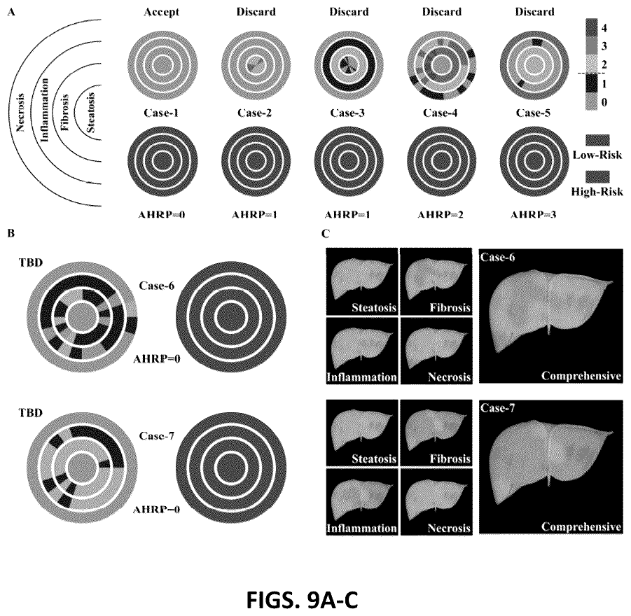

FIGS. 9A-9C depicts the comprehensive assessment of donor liver viability with hepatic steatosis, fibrosis, inflammation, and necrosis by PS-OCT imaging. FIG. 9A depicts suggested decisions for multiple donor liver cases under different conditions. FIG. 9B depicts a representative donor liver case showing significant viability heterogeneity, highlighting the request for a final decision. FIG. 9C depicts a distribution of hepatic heterogeneity under various comprehensive and single-parameter evaluations. AHRP means absolute high-risk parameter. TBD means to be decided, e.g., to be decided whether liver is suitable or non-suitable.

The shortage of available donor livers, driven by the high demand for liver transplantation and persistently high organ discard rates, underscores the urgent need for a reliable pre-transplantation liver viability evaluation tool to help increase transplant numbers, optimize transplant outcomes, and decrease discard rates. We propose using PS-OCT as an imaging modality to perform a comprehensive and nearly real-time viability evaluation by scanning the entire donor liver. To validate the PS-OCT images, we correlated the imaging results with pathological analysis, which is the current gold standard for assessing pretransplant donor liver viability. Our pathologic evaluation of the entire donor liver revealed significant regional heterogeneity in degrees of steatosis, fibrosis, inflammation, and necrosis across the liver surface. These heterogeneities arise partly because hepatocytes in different liver zones vary in enzyme expression and subcellular structures, leading to functional and metabolic differences across the liver at the tissue level. Additionally, hepatic ischemia-reperfusion injury is related to this intrinsic heterogeneity, as certain zones may be more vulnerable to injury. Consequently, biopsy from multiple sites is often necessary to accurately assess hepatic parameters, predict functional potential, and evaluate viability. Our histopathological examination of the donor liver surface revealed these patterns of heterogeneity, aligning with previous reports and reinforcing the importance of multi-site pathological analysis for a comprehensive viability assessment.

Conventional pathology, which relies on analyzing one or two tissue samples, may introduce significant sampling error and negatively impact the accuracy of viability evaluations for the entire donor liver. Furthermore, rapid liver assessment via pathology is not always feasible in hospitals due to the time required for processing, and doing enough biopsies to avoid sampling error is unlikely to be feasible or advisable. The reliability of pathologic findings at different parameter cutoffs or between various pathologists is also a factor that cannot be ignored, as significant inter-observer variability is common. Additionally, liver biopsy are invasive and associated with risks, such as bleeding, despite the small sample size. Our findings align with current clinical concerns regarding the limitations of graft outcome prediction by the LDRI and the gradings in liver viability assessments based on pathology. In PS-OCT images, through noninvasive and noncontact scanning across the entire donor liver, we effectively address these clinical problems by providing comprehensive qualification and quantification of steatosis, fibrosis, inflammation, and necrosis. These four parameters are key indicators for evaluating liver viability for transplantation in pathology assessment. The strong correlation between PS-OCT and pathologic evaluations suggests that PS-OCT, in conjunction with routine pathologic evaluation, can accurately assess donor liver viability and has the potential to achieve fully automated imaging evaluations in the future. Functional tests utilizing biomarkers produced during normothermic machine perfusion is another effective liver viability assessment, however, less than 10% of liver grafts currently undergo machine perfusion due to its complexity and high cost (58). Consequently, the majority (˜90%) of liver viability and graft assessments still rely on pathology, highlighting the importance of PS-OCT imaging for liver assessment. Moreover, the PS-OCT imaging system is compatible with existing ex vivo liver perfusion devices. This allows the microstructural information provided by PS-OCT imaging to be combined with the functional tests collected during ex-vivo perfusion. Our PS-OCT system is based on the widely used spectral-domain OCT, which has proven to be an operationally practical tool for kidney imaging in ongoing clinical trials. PS-OCT could easily be adopted and utilized by clinicians for liver transplantation trials in the future.

Hepatic steatosis is the most critical parameter in liver viability evaluation, with size and density serving as key indicators for grading and quantification. Histologically, steatosis is categorized as microvesicular or macrovesicular. However, current viability evaluations often focus primarily on macrovesicular steatosis. The combined percentage of macro- and micro-steatosis is typically used to assess liver transplant feasibility, with degrees of steatosis classified as mild (<30%), moderate (30%-60%), or severe (>60%). A threshold of 30%-33% macrovesicular steatosis generally determines suitability for use in transplantation, with higher levels indicating unsuitability. However, current pathology grading only provides a quantitative estimation of two-dimensional (2D) steatosis, limited by the constraints of histological staining of liver tissues. In addition to the limitation of regional evaluation from single-sample histology staining, the specific methods used for quantitative evaluation of pathology stains can also introduce errors in liver tissue grading. Fortunately, our results revealed that PS-OCT can directly detect steatosis due to the fat droplet microstructure can be effectively identified by OCT imaging. PS-OCT images enable direct identification and segmentation of steatosis for quantification, as shown in FIG. 2. More importantly, PS-OCT allows for 3D segmentation of steatosis, providing a more reliable measurement of spatial size and volume density compared to traditional pathology. Since PS-OCT quantifies steatosis in 3D, there are quantitative and qualitative differences in steatosis density measurements between PS-OCT and traditional pathology. This discrepancy necessitates the development of a dedicated standard for PS-OCT to quantitatively evaluate hepatic steatosis. To establish this dedicated standard correlation with the clinical threshold of 33%, we used distribution statistics, a widely applied method, to generate a threshold for evaluating hepatic steatosis. With the established steatosis density threshold (0.04%), PS-OCT images not only reveal the heterogeneous distribution of steatosis across the entire donor liver but also display a strong correlation (85%) with the clinical pathology evaluation.

Hepatic fibrosis is a parameter of liver viability evaluation and is associated with hepatic inflammation and necrosis. Hepatic fibrosis is quantitatively evaluated by portal tract fibrosis which refers to the development of fibrous (scar) tissue within the portal tracts of the liver. Different stages of fibrosis can be identified by the progression and extent of fibrous tissue in the liver. Since fibrosis produces birefringence by altering the polarization state of light, PS-OCT polarization images can detect these changes to measure the degree of fibrosis (FIG. 6A-6F). Our results show that the different stages of fibrosis identified in pathology images can also be recognized in corresponding PS-OCT DOPU images. The correlation between different fibrosis stages in PS-OCT and pathology follows a linear relationship, enabling the development of a grading system for hepatic fibrosis detected on PS-OCT DOPU images. Using this grading system, our PS-OCT achieved an 80% correlation accuracy with pathology for specific fibrosis scores and an 85% correlation accuracy for liver viability evaluation. This precise one-to-one alignment has not been achieved with other clinical imaging modalities, including ultrasound, computed tomography (CT), or magnetic resonance imaging (MRI). Although fluorescence imaging and two-photon microscopy can detect different stages of hepatic fibrosis, their clinical utility for liver viability evaluation is limited by the need for imaging dyes, low tissue penetration, and complex sample processing requirements. The noninvasive, high-resolution capabilities of PS-OCT make it an ideal tool for evaluating hepatic fibrosis across the entire liver.

Hepatic inflammation and necrosis are two key tissue alterations resulting from the injury and death of hepatocytes. However, these changes do not cause significant microstructural alterations. As a result, PS-OCT images cannot directly quantify tissue changes associated with inflammation and necrosis. Although these tissue alterations cannot be detected directly, they alter the scattering properties of light, allowing changes in pixel intensity to be measured and used to monitor these alterations. Texture features have been widely used to extract pixel pattern information for remote sensing and medical imaging to segment and classify specific regions of the donor liver. To monitor these pixel intensity changes, we use texture features to classify pixel patterns for quantifying hepatic inflammation and necrosis.

By applying machine learning models, we identified effective features from 27 texture parameters to classify specific scores and risk categories for hepatic inflammation and necrosis. Since 3D PS-OCT intensity images cannot directly distinguish liver tissue at different stages of hepatic inflammation and necrosis, we reconstructed 3D hyperparameter structures by convoluting-summing all effective features. This approach effectively visualizes liver tissue with and without inflammation or necrosis. The feature eigenvalues reveal significant differences across various stages of inflammation and necrosis which cannot be directly quantified by PS-OCT images (FIG. 7A-I and FIG. 8A-I). When validated by pathologic results, PS-OCT shows a strong correlation in classifying hepatic inflammation and necrosis. Notably, PS-OCT demonstrates a relatively stronger correlation with pathologic data when classifying risk categories (low-risk and high-risk) for hepatic inflammation and necrosis than when classifying specific scores. Therefore, it indicates that PS-OCT images combining texture features have a higher sensitivity to classify the risk categories across the entire liver.

We noticed that the top three effective features and the hyperparameter in hepatic necrosis classifications have a fluctuation alteration of feature eigenvalues in evaluation scores. We speculate that advanced stages of hepatic necrosis (scores 3 and 4), which indicate submassive and massive hepatocyte death, may produce structural features indicative of early stages of necrosis (scores 0 and 1) (87). This overlap could potentially disrupt the expected trend changes in texture features.

PS-OCT shows a strong correlation with pathology in classifying evaluation scores and risk categories, particularly achieving high accuracy in predicting final decisions for donor livers with absolute high-risk parameters (AHRP). This finding suggests that PS-OCT may have the potential to replace traditional pathologic analysis for a rapid and comprehensive pretransplant viability evaluation of the entire deceased donor liver. The possible utility of PS-OCT in decreasing the discard rate of higher risk donor livers and to expand the donor pool has not been confirmed. Fortunately, we provide evidence that PS-OCT can also provide the global distribution characteristics of risk categories across the entire liver. For those marginal livers without AHRP, PS-OCT allows the visualization of risk categories (low-risk vs high-risk) to offer a more comprehensive reference to help inform clinical decision-making. Some livers with high-risk risk factors may still be suitable for transplantation if the risks are limited and if they are adequately assessed.

Our results show that donor livers with limited high-risk regions can be further assessed by clinicians to make final decisions for or against use (FIG. 6B), potentially reducing the discard rate of marginal livers and expanding the donor pool. Additionally, with PS-OCT's ability to evaluate viability across the entire liver, marginal livers with limited high-risk factors may still be suitable for partial liver transplantation. It has the potential to help patients in urgent need of transplantation or those who have been on the waiting list for an extended period. Still, reports have documented cases of graft failure following transplantation due to the use of high-risk marginal livers.

Therefore, comprehensive viability evaluation of the entire liver with PS-OCT can help avoid the use of marginal livers with extensive high-risk regions, potentially reducing the risk of primary graft nonfunction (PNF) or early allograft dysfunction (EAD).

Notably, we used 20 deceased donor livers to investigate the feasibility of PS-OCT for liver viability evaluation by quantifying hepatic steatosis, fibrosis, inflammation, and necrosis parameters. The correlation between pathology and PS-OCT for these parameters is based solely on our current sample size. Therefore, the quantitative evaluation and statistical analysis of hepatic steatosis, fibrosis, inflammation, and necrosis are limited to these 20 livers. As the sample size increases, the quantitative indexes for these parameters may fluctuate. It is also important to note that PS-OCT currently provides an imaging depth of approximately 1.0˜2.0 mm in liver tissues due to tissue scattering and laser source limitations. Nonetheless, our study represents a pioneering effort in applying OCT imaging to overcome the limitations of traditional histology, enabling a more comprehensive and reliable evaluation of liver tissues. A comparison of histopathologic scores between liver tissues at depths of 2 mm and ˜2 cm, conducted by three board-certified pathologists, revealed no significant differences in conventional pathology staining. This finding demonstrates that the imaging depth achieved by PS-OCT in this study is sufficient to obtain effective depth information for liver tissue assessment. With advancements in OCT modalities, such as longer-wavelength laser sources or matrix imaging modes, PS-OCT has the potential to achieve much higher penetration depth, making it a promising tool for clinical liver assessment. On the other hand, the detection and quantification of hepatic fibrosis based on DOPU are based on the cumulative values due to the single input polarization state in our PS-OCT system.

As a result, the local polarization information cannot be quantitatively provided. However, since the local birefringence mode is directly proportional to the actual birefringent signal intensity per pixel, the cumulative polarization signal offers higher sensitivity compared to the local polarization signal.

A recent report demonstrated that a polarization state tracing method, which follows the polarization evolution in depth along the Poincare sphere, can extract the local birefringence signal using a single input polarization state. By applying differential calculations to account for the transmission differences between adjacent layers, our PS-OCT imaging has the potential to reveal local fibrosis information effectively in the future study. Moreover, it is important to note that no test is perfectly reliable in assessment of graft viability. While our PS-OCT imaging significantly enhances liver viability evaluation compared to traditional pathology, pathology staining may still be required in specific high-risk zones (as in FIG. 9B) to support a final decision. As the imaging time for the entire liver is currently constrained by the field-of-view (FOV) of the PS-OCT system, we are exploring the use of a space-division multiplexing OCT system to simultaneously acquire several parallel imaging zones, enabling wide-field imaging of liver tissues and significantly reducing imaging time. Because PS-OCT intensity and polarization imaging provide only structural information, we have not yet obtained functional viability assessments, such as lactate clearance analysis. However, advancements in dynamic OCT have enabled functional imaging of metabolism and inflammation in mouse livers, presenting a promising pathway for developing a dynamic PS-OCT system to evaluate the functional viability (e.g., metabolism) of ex vivo human livers in future studies. Furthermore, with the advent of machine perfusion to enhance organ viability assessment, optimize organ quality, and extend preservation time, Doppler OCT may hold promise in the assessment of the functional characteristics of blood flow within the liver.

In this study, we explored the feasibility of using PS-OCT for comprehensive viability evaluation of pre-transplantation deceased donor livers. Through pathological analysis, we identified significant heterogeneity in hepatic steatosis, fibrosis, inflammation, and necrosis across the entire donor liver surface, underscoring the necessity for global viability evaluation. We demonstrated that PS-OCT images provide spatially quantitative information on these parameters throughout the liver. Utilizing texture features and machine learning models, PS-OCT enabled a more comprehensive viability assessment and visualization of its distribution. Our findings suggest that PS-OCT has the potential to reduce discard rates for high-risk livers, thereby expanding the donor pool. This study offers new insights into the application of PS-OCT imaging for improving the viability evaluation process in human liver transplantation.

### Example 2—Comprehensive Evaluation of Human Donor Liver Viability with Polarization-Sensitive Optical Coherence Tomography

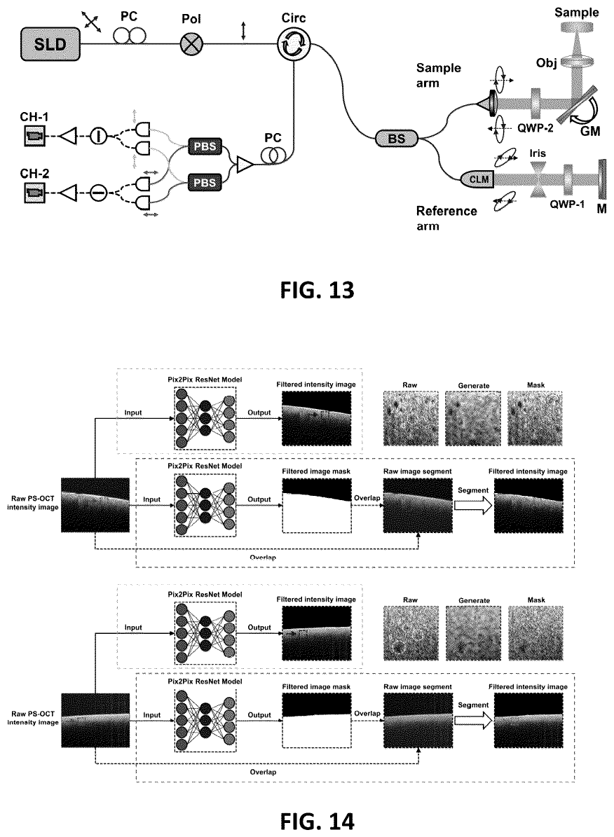

FIG. 13 illustrates the schematic representation of a custom-designed polarization-sensitive optical coherence tomography (PS-OCT) system utilized for imaging ex vivo deceased donor livers. The laser source is a broadband superluminescent diode (SLD) with a center wavelength of 1300 nm and a spectral bandwidth of 100 nm.

FIG. 13 depicts a broadband Light Source, 1300 nm center wavelength linear-polarized light. PC, polarization controller. Pol, polarizer. Circ, circulator. CLM, fiber-to-free-space collimator. BS, beam splitter. Iris, adjustable iris. QWP-1, quarter-wave plate (orientation ˜22.5°). QWP-2, quarter-wave plate (orientation ˜) 45°. GM, galvanometer. Obj, objective. M, mirror. PBS, polarization-sensitive beam splitter. CH-1, channel-1 sensor. CH-2, channel-2 sensor. Sample Arm of Interferometer, incident circular light-equal light amplitude in both orthogonal polarizations, backscattered and reflected elliptical light-encoded polarization and intensity information.

Vertical linearly-polarized light is generated using a polarizer (Pol) and then is directed into polarization-maintaining fibers, subsequently being divided into reference and sample arms through a beam splitter (BS). In the reference arm, the linearly polarized light passes through a zero-order quarter-wave plate (QWP-1) oriented at 22.5 degrees and exits with a 45-degree linear polarization after traversing QWP-1 twice. Within the sample arm, the polarized light passes through a zero-order quarter-wave plate (QWP-2) oriented at 45 degrees, thereby transforming it into circularly polarized light. Upon interaction with the sample, the polarized light undergoes reflection and scattering, resulting in an elliptical polarization state after passing through QWP-2. The recombined polarized light from both arms of the system is then split into the vertical linearly polarized signal and horizontal linearly polarized signal by two polarization-sensitive beam splitters (PBS). Subsequently, these signals are detected and processed by two polarization-sensitive channel sensors (CH-1, CH-2). The detected two orthogonal polarization state lights allow for the analysis of how the tissue alters the polarization state of the light, revealing tissue structure and composition information, particularly regarding the presence of birefringent structures within the tissue. This system provided an axial resolution of 5.5 μm and a lateral resolution of 13 μm in the air with a sensitivity of 105 dB at 48 KHz A-scan rate (l). The imaging area at each labeled position was focused on the center of the ink-labeled circle. A field-of-view (FOV) measuring 5×5×2.6 mm³ (X, Y, Z) with a size of 1000×1000×1024 pixels in the X, Y, and Z directions was employed, yielding a sampling resolution of 5×5×2.6 μm³ during liver imaging. The PS-OCT system will generate the Stokes parameters (Q, U, and V) by analyzing the polarization state of light reflected from the sample, which are derived from the intensity measurements of different polarization components of the backscattered light. These parameters are combined to compute the degree of polarization uniformity (DOPU), a metric that quantitatively assesses tissue birefringence by evaluating the consistency of polarization states within a local region (2). This process enables the PS-OCT system to noninvasively and efficiently characterize tissue collagen and integrity.

### Histopathological Tissue Processing and Grading

After PS-OCT imaging, all labeled regions across the entire liver were sectioned and processed for histological staining to compare with corresponding PS-OCT results. At each labeled position on the liver surface, a square area encompassing the central region inside the circle was systematically sampled. The sectioned liver tissue was fixed with 10% formalin, embedded in paraffin, then stained for histological analysis. The biopsy was manipulated and finished by the Tissue Pathology Shared Resource, Stephenson Cancer Center (SCC), and University of Oklahoma Health Sciences Center. The histopathology stains were graded by three board-certified pathologists to generate hepatic viability scores. Each score was finalized through consensus among the three pathologists. In case of dissonant assessments, a consensus workshop was held to establish an agreed-upon final score. To match the imaging penetration depth of PS-OCT (˜2 mm) with the pathology examination depth (1.5˜2.0 cm), we compared the grading of 30 pathology slides from three donor livers between the full slide thickness (1.5˜2.0 cm) and the top 2 mm section, as assessed by the three pathologists. No significant difference in pathological grading between the full slide and the top 2 mm section was found. This finding suggests that PS-OCT's imaging depth provides sufficient structural information for viability evaluation.

### Deep-Learning-Based Image Pre-Processing

To address reflection noise caused by the smooth liver surface and background noise in raw PS-OCT images, we applied deep learning-based image denoising during preprocessing. A total of 1,000 cross-sectional 3D PS-OCT images from each labeled region were preprocessed to enable auto-recognition of steatosis microstructures and texture feature extraction. Pix2Pix, U-Net, Resnet50, and Segment Anything Model (SAM) model were employed to remove upper-surface reflections and background noise, producing a region-of-interest (ROI) mask. The Resnet50, U-Net, and Pix2Pix models were compiled on Python (Python Org) while the pre-trained Segment Anything Model (SAM) was applied through the Imagesegmenter application on MATLAB (MATLAB Inc.). 4,842 2D PS-OCT intensity images were employed for training models (Resnet50, U-Net, Pix2Pix), 605 images were utilized for validating models (Resnet50, U-Net, Pix2Pix, SAM), and 606 images were used for testing models (Resnet50, U-Net, Pix2Pix, SAM). The accuracy metric evaluates binary pixel accuracy while the intersection over union (IOU) evaluates the accuracy of overlapping regions of the mask generated by the model and the ground truth (manual labeled liver tissue region). The mean square error (MSE) objectively quantifies the magnitude of the errors between the predicted image and the ground truth. The structural similarity index metric assesses quantitative image quality in three structural aspects-luminance, contrast and structure thus overcoming limitations in traditional metrics such as MSE that assume statistical features are spatially stationary. The peak signal-to-noise-ratio (PSNR) evaluates the quality model segmentation by comparing the ratio between the power of the signal noise and the maximum power of the signal. Higher PSNR scores indicate the higher quality of the masks generated by the model. The Pix2pix model, which includes a modified U-Net generator and a discriminator, outperformed the simple U-Net model, Resnet50 model, and Segment Anything Model (SAM).

The pixel to pixel (Pix2Pix) is a conditional generative adversarial network (CGAN) that learns to map input images to output images in image-to-image translation tasks. The Pix2Pix architecture comprises of a U-net-based image generator and a convolutional PatchGAN classifier. The U-Net model consists of an encoder (downsampler) and a decoder (upsampler) with unique skip connections and has the advantage of achieving high segmentation accuracy with fewer training images. The role of the discriminator in the Pix2Pix model is to evaluate each image patch generated by the generator, classifying it as real or synthetic, which helps the generator produce more realistic outputs. In this study, the Pix2Pix model is used to filter noise in PS-OCT images and enhance tissue features by learning the mapping from noisy to clean images through paired training data. This approach enables the model to denoise while simultaneously improving the recognition of liver tissue structures, leveraging its advantage of fewer training parameters and faster compilation times. Specifically, the Pix2Pix generator uses a U-Net architecture with 8 downsampling layers (64-512 filters, LeakyReLU) and 7 upsampling layers (64-512 filters, ReLU, skip connections), with a final output resolution of 256×256×3 and Tanh activation. The discriminator employs a PatchGAN architecture with 3 downsampling layers (64-256 filters, LeakyReLU) and two convolutional layers to classify 30×30 patches as real or fake. The model is trained with a batch size of 1, using an adversarial loss (Binary Crossentropy) combined with an L1 loss (weighted by λ=100), optimized with Adam (lr=5e-4, β1=0.5).

However, when a filtered image was directly regenerated using the Pix2Pix U-Net model, the original signal of the sample microstructure was altered, introducing errors into subsequent image processing and microstructure recognition. To mitigate this issue, we proposed a mask-assisted segmentation method. In this approach, the Pix2Pix U-Net model generates an ROI mask that is used to segment the denoised ROI from the original image, preserving the original signals (FIG. 14). To evaluate the performance of our method, we compared the results of our mask-assisted filtering approach with those of the direct filtering approach. Six representative regions from the raw image, directly filtered image, and mask-assisted filtered image were selected for comparison. Unlike the direct filtering method, which altered the original signals and introduced errors in microstructures, our mask-assisted filtering method preserved the original PS-OCT intensity signals. These differences were evident in the six selected regions (yellow, cyan, and pink circles within the red, blue, and green frames).

### PS-OCT Imaging for Steatosis Quantification

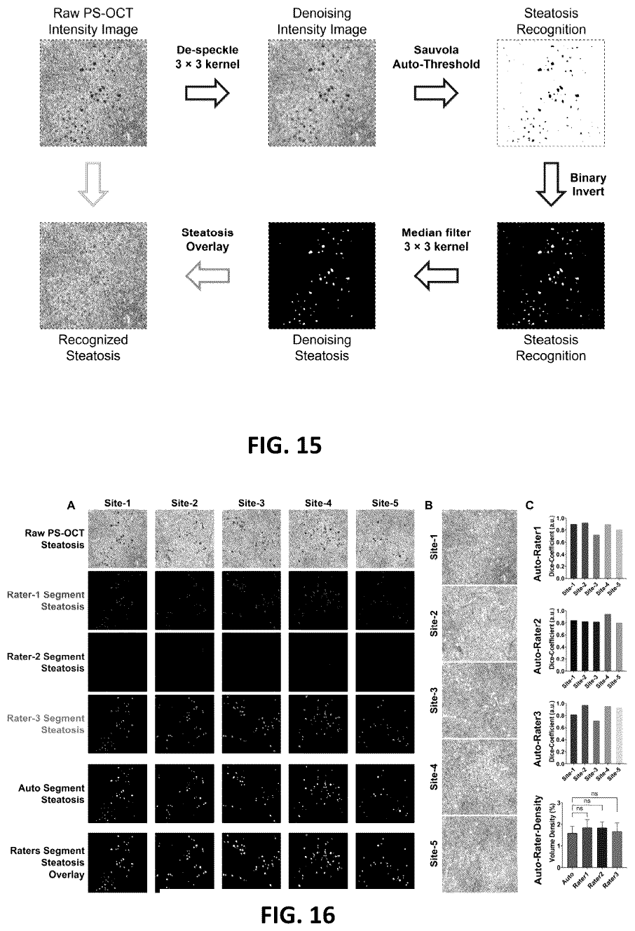

The denoised ROI image was flattened to make the liver capsule upper surface remain on the same height in the cross-sectional image. The flattened cross-sectional image set was resliced to the enface image. 200 enface frames were selected to build a volumetric liver tissue with 500 μm in depth. A Sauvola auto-local threshold algorithm was used to extract the steatosis microstructure from each enface frame (FIG. 15) and the 3D steatosis is reconstructed by stacking the 2D steatosis from all selected frames. A raw PS-OCT intensity image was filtered by a 3×3 kernel de-speckle matrix to remove the speckle noise. The denoised intensity image was processed by the Sauvola Auto-Threshold algorithm to segment steatosis microstructures from liver tissues. The recognized steatosis image was inverted and filtered by a 3×3 kernel median filter to remove the recognition errors. The denoised steatosis image was used to quantify the density of steatosis. FIG. 15 shows the overlay of the auto-segmented steatosis with the raw PS-OCT intensity image, which exhibits a high recognition accuracy of our automatic segmentation method.

To compare the segmentation accuracy of hepatic steatosis from PS-OCT intensity images by the Sauvola Auto-Threshold algorithm, three raters were recruited to manually label the hepatic steatosis for the quantification. We provided five representative PS-OCT intensity images with substantial hepatic steatosis. The Sauvola Auto-Threshold algorithm and three raters automatically segmented the steatosis and manually labeled the steatosis for the five images, respectively. FIG. 16A shows the manually labeled steatosis and automatic segmented steatosis from the three raters and the Sauvola Auto-Threshold algorithm. We present the overlay of the manually labeled steatosis from the three raters and found there is a strong match of the labeled steatosis from the three raters.

FIG. 16B displays the overlayed steatosis images from the three raters to the corresponding raw PS-OCT intensity images. Dice coefficient was used to evaluate the degree of the agreement between our automatic segmentation method and the rater manual labeling.

FIG. 16C is the steatosis density comparison performance between the automatic segmentation and each rater. Our result shows that there is a high match between automatic segmented steatosis and manual labeled steatosis (dice coefficient is in the range of 0.71˜0.98). The steatosis density quantification using either our automatic segmentation algorithm or the rater manual labeling shows no significant difference.

### PS-OCT DOPU for Fibrosis Quantification

The fibrosis signals were extracted from each raw PS-OCT DOPU image by employing five thresholds of 0.5, 0.6, 0.7, 0.8, and 0.9. Five featured fibrosis regions with the DOPU values of 0.5˜1.0, 0.6˜1.0, 0.7˜1.0, 0.8˜1.0, and 0.9˜1.0 were collected for each DOPU image to quantify the fibrosis through the percentage ratio between the featured fibrosis and the overall hepatic tissue areas. A clinical histopathological score with a range of 0˜4 for the fibrosis level of each labeled area was provided by board-certified pathologists as a standard of fibrosis quantification. Each 3D PS-OCT DOPU data has a corresponding histopathologic fibrosis score at each labeled region. To obtain the optimal threshold of obtaining fibrosis levels from PS-OCT DOPU images, linear fitting was performed between each of the five featured percentage ratios and the standard histological score to correlate the pathological score and PS-OCT DOPU data. The threshold with a featured DOPU value corresponding to the highest R-square value in the fitting was selected as the optimal threshold to extract fibrosis signals from hepatic tissues. In this study, 252 labeled areas from 10 donor livers were employed for the correlation between pathology and PS-OCT DOPU images. With the optimal threshold, each percentage ratio of the featured fibrosis area was utilized to present the fibrosis level of the hepatic tissue in each DOPU image. The overall spatial fibrosis score of each labeled area on the donor liver was composed of the average percentage ratio of 1000 2D PS-OCT DOPU images.

### Texture Feature Extraction for Hepatic Inflammation and Necrosis Assessment

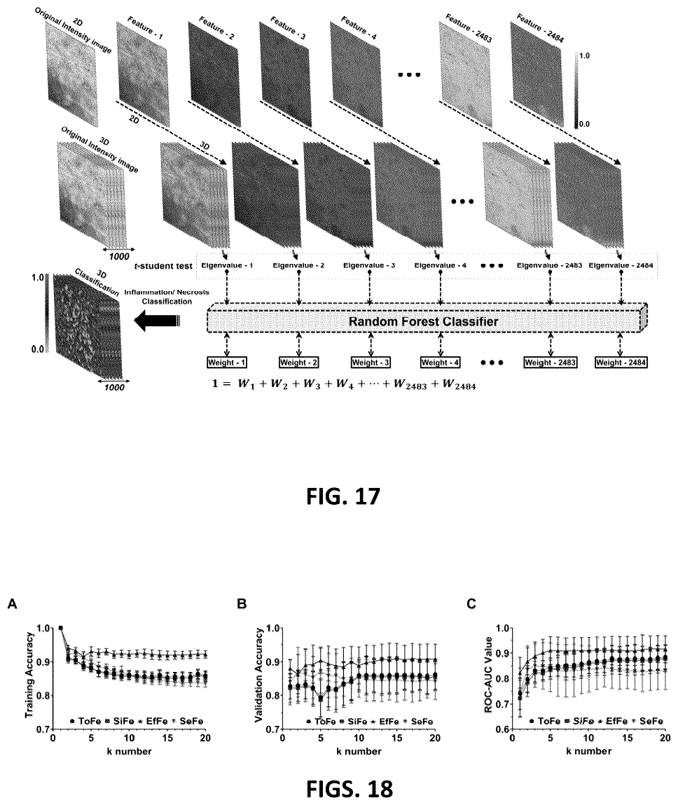

Hepatic inflammation and necrosis, which involve cellular microstructure alterations, are difficult to detect directly using PS-OCT intensity or polarization imaging, especially in the early stages. However, these microstructural changes affected tissue distribution, which can be captured through the pixel distribution characteristics of optical images. Texture features of images describe and quantify spatial and surface properties of objects or regions, such as smoothness, roughness, or coarseness by analyzing the spatial arrangement, size, shape, and spacing of pixels. We applied 27 texture parameters to extract 2,484 texture features from a single 2D PS-OCT intensity frame (multiple features from each texture parameter, as shown in FIG. 17).

These parameters are used to extract statistical, structural, model-based, and spatial features of images. The detailed parameters and features have been reported in our previous study (8). For each 3D PS-OCT intensity data that is composed of 1,000 2D PS-OCT intensity frames, there are 2,484×1,000 2D texture features that were extracted. A 7×7 kernel was used to extract 2,484 texture feature values for each pixel within each 2D DOPU image. To obtain the 3D spatial texture feature eigenvalues, the average eigenvalue of 1,000 2D texture feature eigenvalue of each texture feature in the 3D PS-OCT data was calculated (FIG. 17).

Thereby 2,484 3D texture feature eigenvalues of each 3D PS-OCT intensity data was generated. To acquire effective texture features for classifying hepatic inflammation and necrosis from PS-OCT intensity images, the unpaired t-student test and random forest learning model were used for the feature screening. 10 donor livers were utilized for effective feature screening by t-student test and random forest model. The texture features with the significant difference among groups (Low-Risk vs High-Risk and Score 0 vs 1 vs 2 vs 3) based on pathology scores were screened as significant features. A random forest model with a 1.0 training rate and 99% classification accuracy (ROC-AUC=0.99) was employed to screen the effective feature with contributions for classification (weight >0.0) from significant features. Additionally, the random forest model outputs the weight of each effective feature in classifying inflammation and necrosis. To quantify and visualize the screened effective feature structures from PS-OCT intensity images, a convolutional calculation of each effective feature and the corresponding weight was implemented. The sum of the convolution eigenvalues will be acquired as the composite hyperparameter value.

### Machine Learning Model in Screening Effective Texture Features

Extracted texture features include effective features (with feature difference) and ineffective features (without feature difference) from PS-OCT intensity images. To screen effective features, we applied machine learning models to classify and verify hepatic tissues with different levels of necrosis and inflammation based on clinical pathology scores. The random forest learning model was trained to classify four scores (0, 1, 2, and 3) and two risk categories (low-risk˜0/1 and high-risk˜2/3) of necrosis and inflammation from PS-OCT texture feature images based on clinical pathology scores, respectively. A 100% rate of training data was utilized to output the weight of each feature within the classification of hepatic tissues. A threshold of over 0% in the weight of classification contribution was employed to select effective features. The details of effective feature selections by a random forest model are described in FIG. 17.

Five supervised learning models (K-Nearest Neighbor (kNN), Gradient Boosting (GB), Decision Tree (DT), Naïve Bayes (NB), and Support Vector Machine (SVM)) were applied to verify the classification performance of the selected effective features with a ratio of 80%:20% of training versus testing data. To compare the classification performance of our effective feature inputs and other related feature inputs, we applied a k-nearest neighbor (kNN) learning model to classify the hepatic inflammation. 10 donor livers (252 sites) were utilized for comparison. The training accuracy, validation accuracy, and ROC-AUC value were acquired to compare the classification performance from the kNN model with different k numbers (k=20).

FIG. 18A and FIG. 18B show that the kNN model with k≥5 has a significantly higher training and validation accuracy classification with effective feature inputs. Meanwhile, the kNN model has a significantly higher ROC-AUC value under the effective feature inputs, which indicates that our effective feature inputs can improve classification accuracy (FIG. 18C).

### Results

### Virtual 3D Reconstruction of Liver Score Mapping

To visualize the spatial distribution of liver viability scores across the entire donor liver, we created a virtual three-dimensional (3D) liver model (FIG. 10A-10L, 3DModels.org) and built a 3D reconstruction map of liver viability scores. We recorded the scanning positions on each donor liver and labeled these positions on the virtual 3D model for point labeling (FIG. 10B). This point labeling image was binarized to produce a binary labeling image (FIG. 10C). Next, we extracted edges from the binary labeling image to create an edge labeling image (Fig. S1D). The labeling points were digitized (gray values 0˜255) based on the corresponding liver viability scores (PS-OCT or biopsy), resulting in a score labeling image (FIG. 10E). To cover the entire liver surface with scanning points, we expanded the digitized points into digitalized circles using a Gaussian diffusion algorithm. The resulting score diffusion image (FIG. 10F) estimated viability scores for areas not scanned by averaging scores from surrounding digitized circles.

We then removed the edges of the liver outlines and the digitized circles to obtain an edge removal diffusion image (FIG. 10G). A liver shape mask was applied to segment the region of interest from this image, creating a shape segmentation image (FIG. 10H). We used a 15×15 kernel Gaussian blur algorithm to filter the shape segmentation image, producing a Gaussian diffusion filtering image (FIG. 10I). Finally, we colorized this image using the Fire color palette to create a Fire color mapping (FIG. 10J), which was overlaid with 25% transparency onto a processed virtual gray 3D model (FIG. 10K), resulting in a virtual color 3D overlap image (FL).

### PS-OCT Imaging of Microstructure and Fibrosis Tissue

PS-OCT image hepatic microstructures and fibrosis by intensity, and polarization images. Representative images of hepatic microstructures and fibrosis from intensity, phase retardation, optic axis, DOPU, Stokes-Q, Stokes-U, and Stokes-V. PS-OCT intensity image directly provides the structural imaging of liver tissues such as capsules and blood vessels may, for example, be used. Stokes parameters (Q, U, V) were used to describe the polarization state of light to characterize the polarization properties of the hepatic tissues. Phase retardation and optic axis qualify the cumulative hepatic fibrosis by using Stokes-Q, Stokes-U, and Stokes-V parameters. Additionally, DOPU, calculated by Stokes-Q, -U, and -V parameters, was used to quantify the cumulative hepatic fibrosis.

### Effective Texture Feature Extraction for Hepatic Inflammation

We screen the effective features for the hepatic inflammation classification and rank effective features based on the corresponding weight. In the specific score classification (i.e., 0 vs 1 vs 2 vs 3), the weight is between 0.0002 and 0.27247 for 310 effective features in 252 imaging sites. In the clinical-based thresholding score classification (i.e., Low-risk (0 and 1) vs high-risk (2 and 3)), there are 435 effective features screened in 252 imaging sites and the corresponding weight of screened effective features is 0.0005˜0.22512. The feature eigenvalue of all effective features is normalized between 0.0 and 1.0.

### Effective Texture Feature Extraction for Hepatic Necrosis

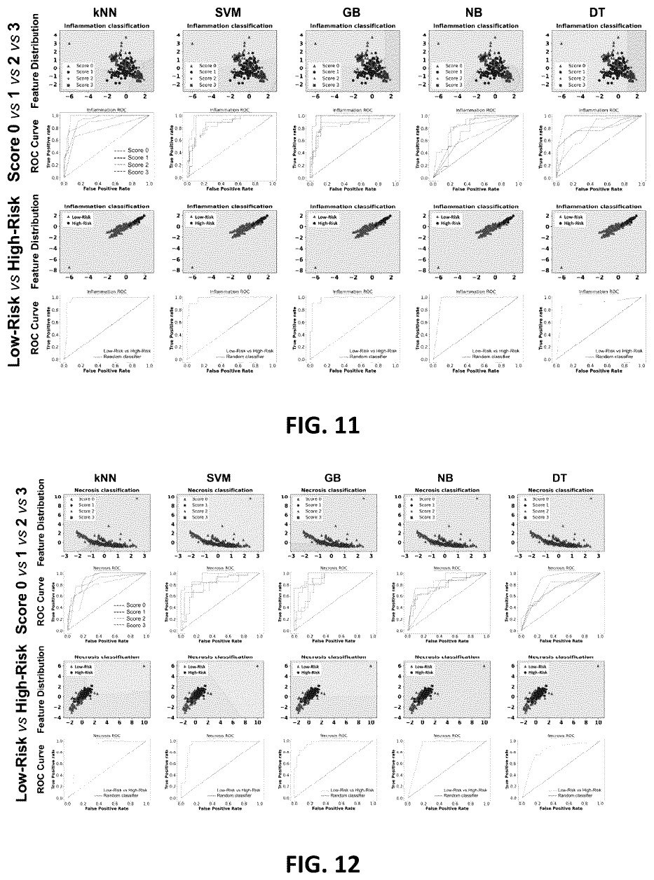

FIG. 11 depicts the evaluation and performance of machine learning models in hepatic inflammation classification and texture feature distribution based on PS-OCT intensity image. We screen the effective features for the hepatic necrosis classification and rank effective features based on the corresponding weight. In the specific score classification (i.e., 0 vs 1 vs 2 vs 3), the weight is between 0.0002 and 0.07515 for 313 effective features in 252 imaging sites (FIG. 12A). In the clinical-based thresholding score classification (i.e., Low-risk (0 and 1) vs high-risk (2 and 3)), there are 871 effective features screened in 252 imaging sites and the corresponding weight of screened effective features is 0.0002˜0.16249 (FIG. 12B). The feature eigenvalue of all effective features is normalized between 0.0 and 1.0.

### Example 3—Pre-Transplantation Evaluation of Human Liver Using PS-OCT System

Materials and Methods: >1500 sampling locations from 15 human livers with different ages and genders were imaged using a polarization-sensitive optical coherence tomography (PS-OCT) system. Two-dimensional (2D) and three-dimensional (3D) imaging modes were used to provide cross-sectional, enface, and spatial information of the livers for distinguishing and localizing the distribution of different microstructures and tissues. Three polarization parameters (phase retardation, optic axis direction, and degree of polarization uniformity-DOPU) and three Stokes parameters (Q, U, and V) were utilized for multi-parameter image analyses and quantification. After OCT imaging, each sampling location was biopsied and processed by both standard and special histological staining. The histological score for each biopsied tissue was graded by a board-certified pathologist. The commonly used histology scoring system was used as the gold standard to quantify the performance of PS-OCT in pre-transplantation liver quality evaluation.

Results: In this work, we observed that globules, steatosis, necrosis, and granuloma, etc. in 2D cross-sectional and enface dimensions were clearly differentiated in PS-OCT structure images, which were consistent with conventional histological images. With the histological staining providing the spatial structure and tissue distribution of liver tissues as the golden standard, PS-OCT precisely identified the fibrosis and collagen and showed the corresponding distributions based on polarization and Stokes parameters in the enface slices at different locations and depths within the whole liver. We found that the distribution and change of microstructures and functional tissues were ununiform and heterogenous within the whole liver, which resulted a big difference in evaluations from different locations on the liver if using biopsy. Compared to the conventional sole biopsy method, PS-OCT was able to noninvasively provide microstructure information and tissue distribution characteristics throughout the whole liver to offer a comprehensive evaluation of pre-transplantation livers. PS-OCT effectively provided evaluation and quantification information on liver microstructure and tissue distributions within human livers using polarization and Stokes parameters, which precisely distinguished and quantified changes in structures and tissues at different locations from the whole liver to offer a comprehensive evaluation of the pre-transplantation liver quality. The results demonstrate that PS-OCT can be used to provide a noninvasive quantitative evaluation of the pre-transplantation quality throughout the whole of the liver and thus can be used as a tool in transplant clinics.

### Example 4—Pre-Transplantation Evaluation of Human Liver Using Polarization-Sensitive Optical Coherence Tomography

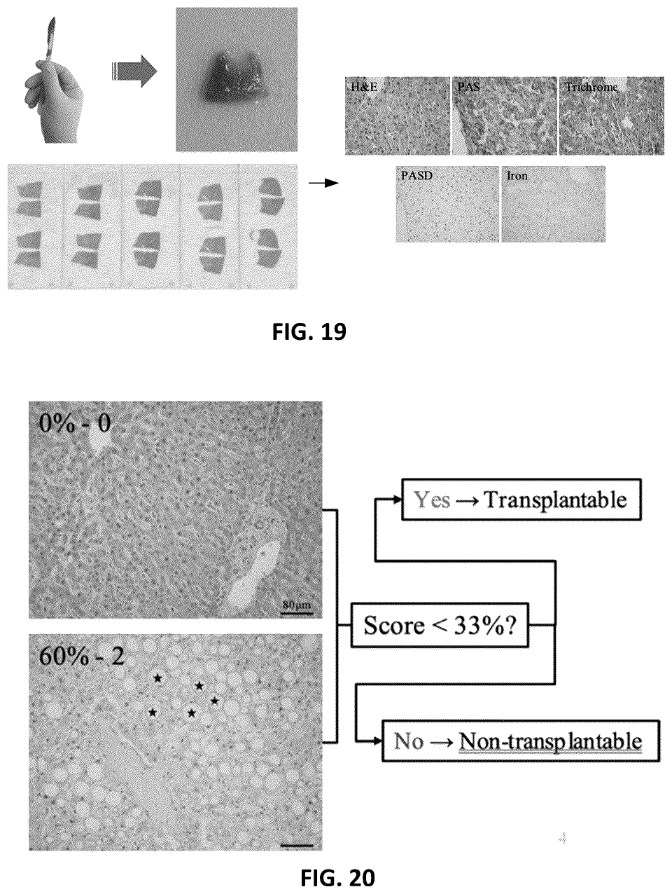

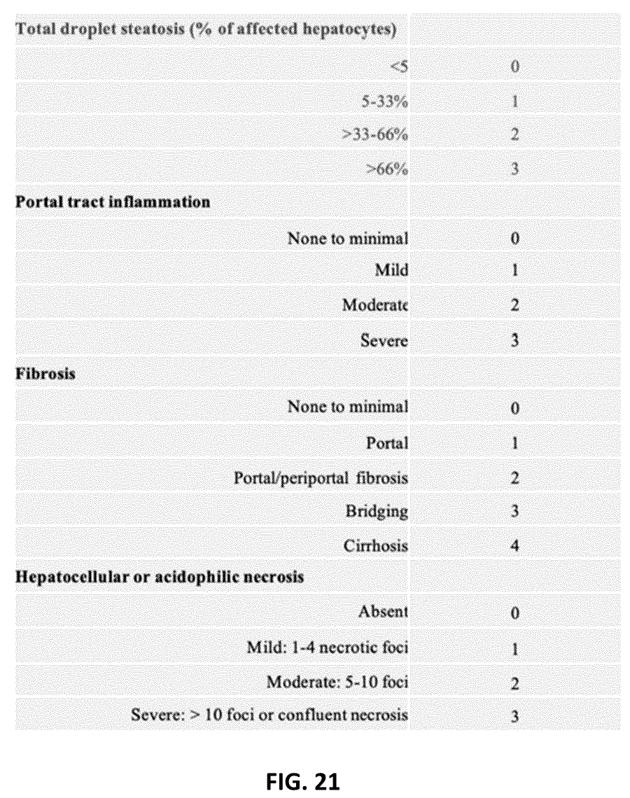

In a liver transplant, a seriously diseased liver is replaced with a healthy liver from a deceased donor. To confirm that the donor liver is of suitable quality for transplantation into a recipient, a histopathological assessment is made during which tests on portions of a single biopsied sample of the liver are conducted (FIG. 19) using a number of different stains. Possible infections are also assessed. Based on the single sample, the liver is given a score based on the ratings for various liver conditions and states (FIG. 21). If the liver meets a predetermined acceptable score, the liver is considered to be suitable for transplantation into a recipient (FIG. 20). However, the question remains as to whether or not a single small tissue sample is adequate to make a suitability determination for an entire liver, considering that the liver is a large organ and typically weighs in the range of 2-4 pounds.

The results described herein assess how tissue quality varies in different areas of the liver and if more than one area of the liver should be evaluated to determine the quality of the entire liver before transplantation.

### Methods

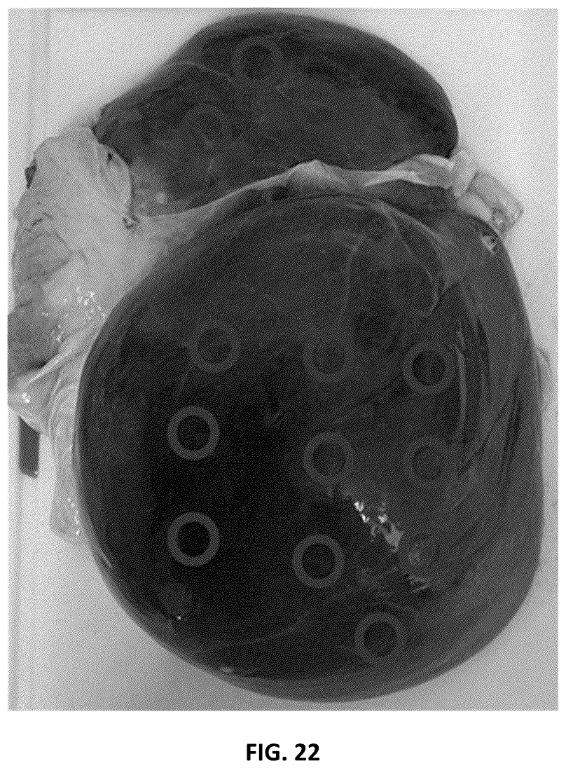

In one experiment, a liver was obtained. Multiple locations on the liver surface were labeled (FIG. 22). One piece of tissue was cut from each labeled location. Five histology stains were processed for each liver tissue sample (as in FIG. 19). The histology performance of each location was scored by a pathologist, using the scoring system of FIG. 21. The results were used to map the distribution of steatosis at the different locations of the liver.

Optical Coherence Tomography (OCT). OCT provides axial resolution at a micrometer level (e.g., about 1-25 μm) and image penetration at a millimeter level (e.g., about 0.5-5 mm) with noninvasive and noncontact scanning. OCT is able to provide 2D and 3D cross-sectional and spatial microstructural information. Polarization-sensitive (PS) OCT can provide information about fibrous tissue in the liver.

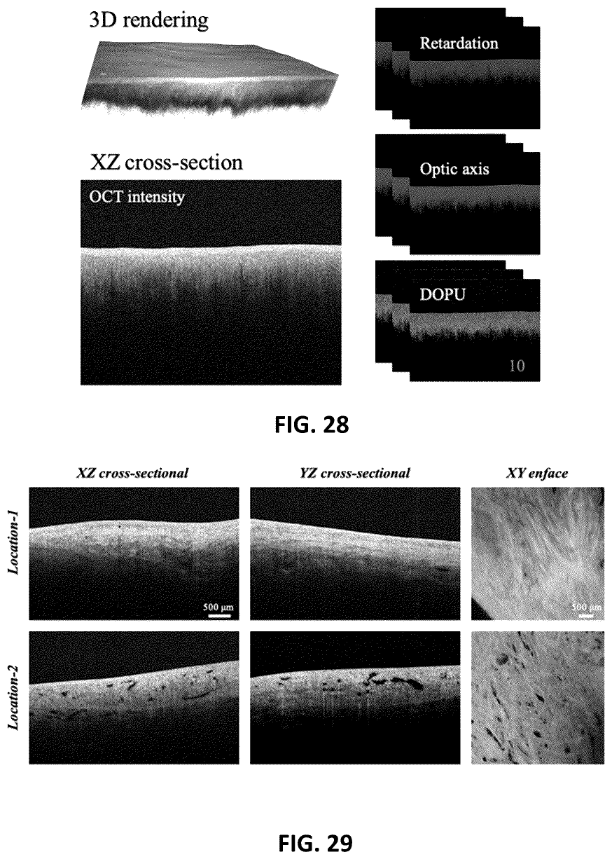

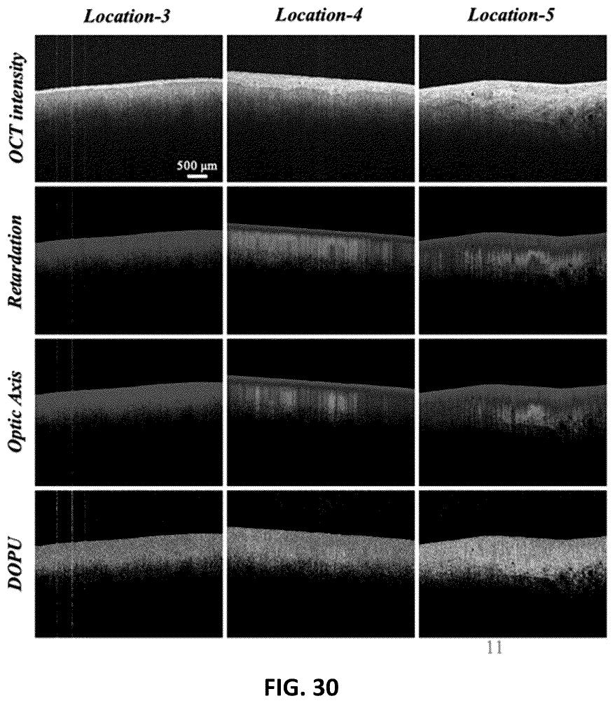

Experiments were carried out on a liver using OCT, wherein intensity levels revealed variations in microstructure at different locations (see FIGS. 28-30), highlighting the inherent heterogeneity in liver tissue microstructure, such as the presence of tubes, holes, and capsule thickness. OCT polarization images exhibit heterogeneities in tissue distribution at different locations, indicating the characterization of fibrosis in liver tissues.

### Results

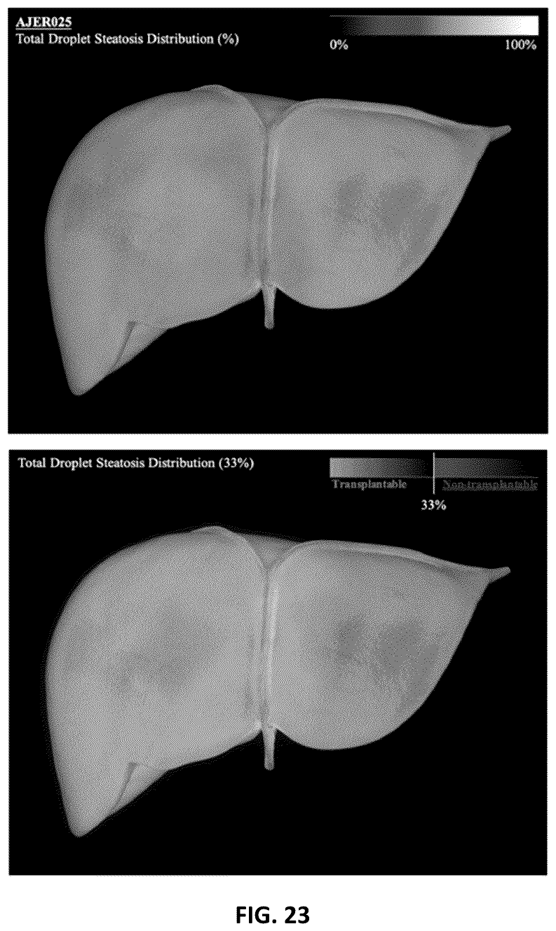

The liver scans shown in FIG. 23 show that the distribution of steatosis is heterogeneous on the entire liver surface. These results demonstrate that a single tissue sample cannot necessarily characterize the quality of the entire liver. However, liver tissue slicing is invasive so multiple location histology assessments for the entire liver are not feasible. Therefore, a non-invasive technique that can replace tissue sample histology for quality assessment of the entire liver is needed.

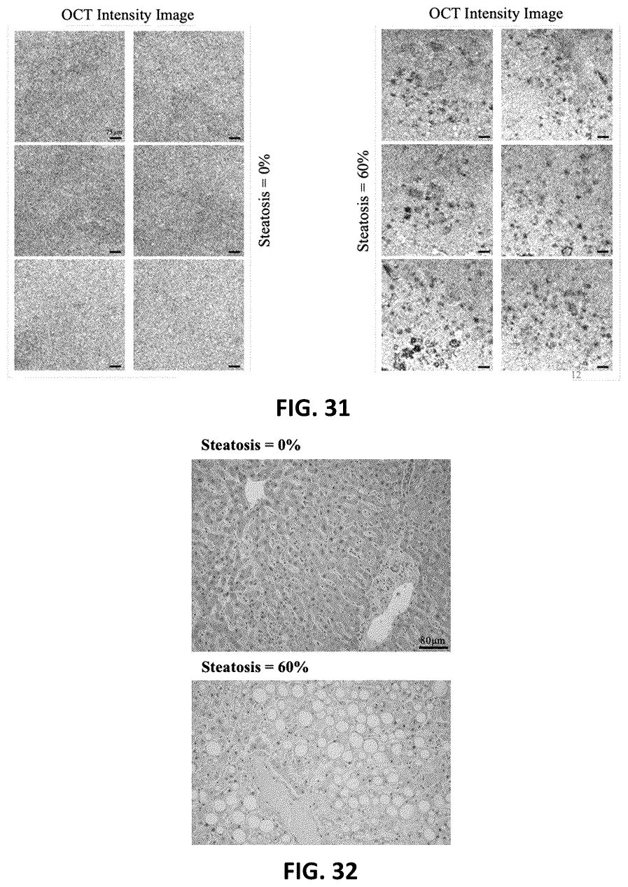

PS-OCT was able to distinguish liver tissues with/without steatosis (FIG. 31) and was able to locate steatosis droplet structures (see FIG. 32).

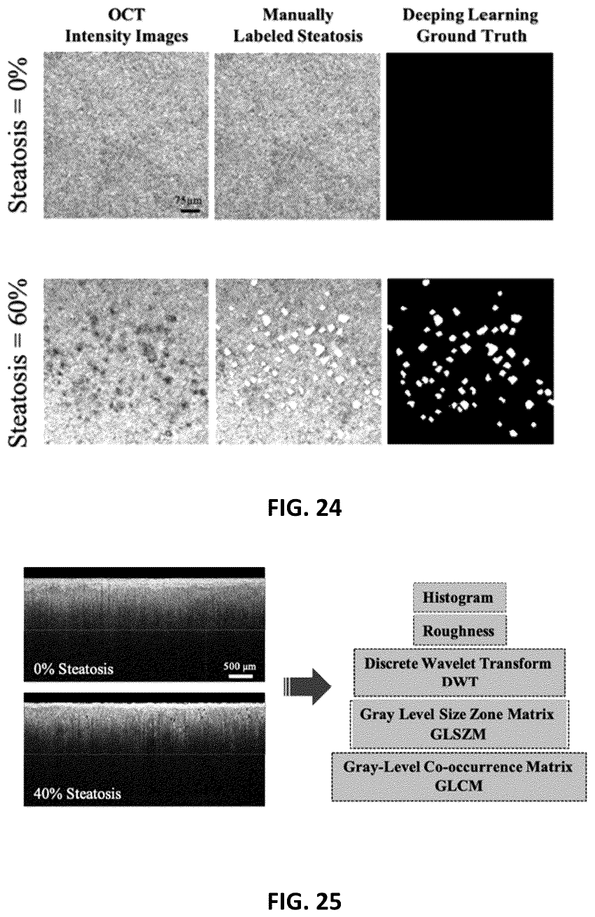

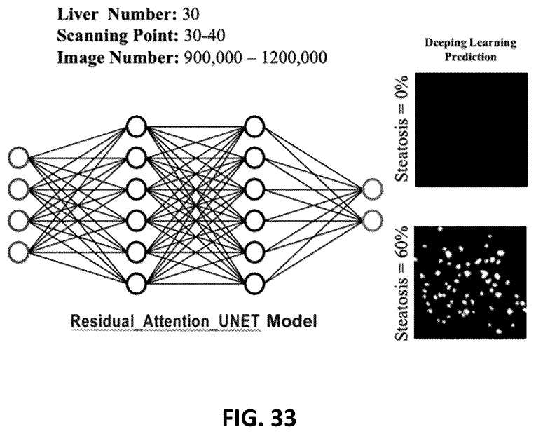

Obtain OCT intensity images for liver tissues. Manually labeled steatosis microstructures. Train deep learning models to recognize steatosis (FIG. 24 and FIG. 33).

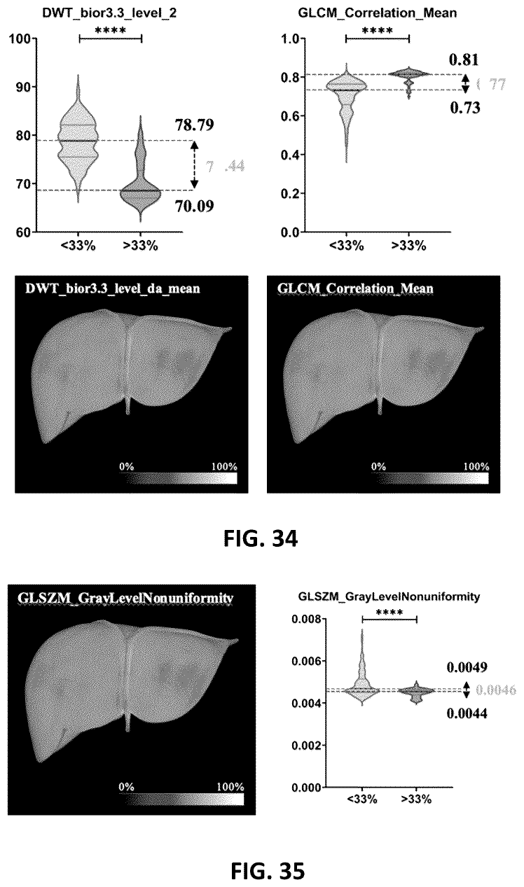

Find the feature value of steatosis of <33% and >33%, then set the threshold using the average of feature values to separate (FIGS. 34-35).

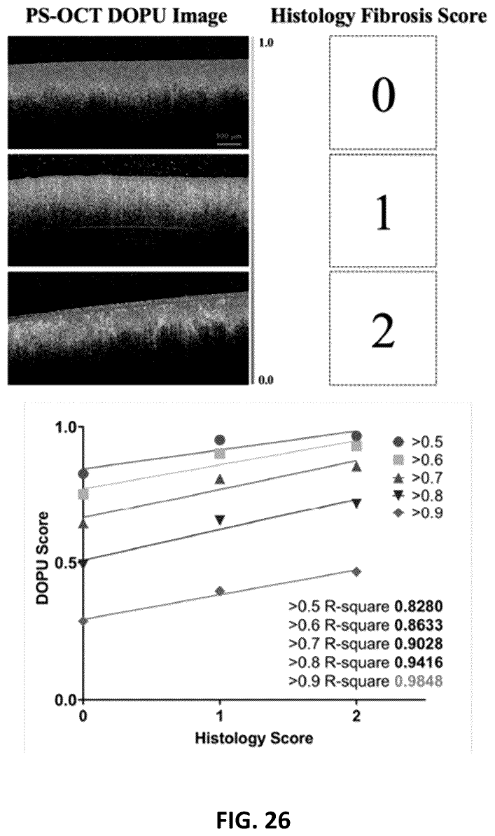

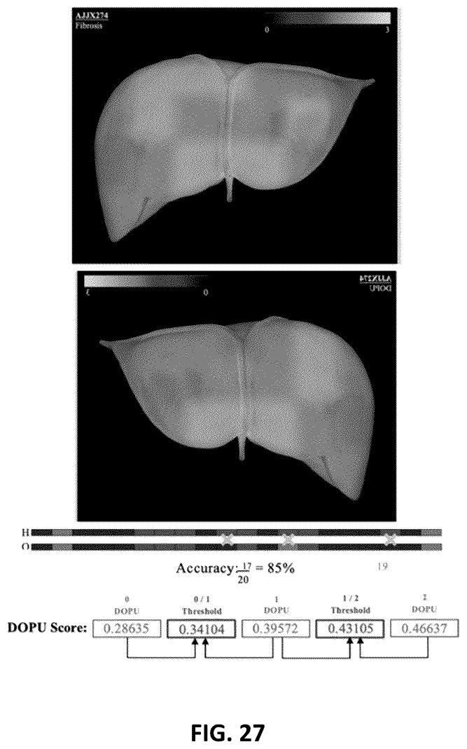

PS-OCT DOPU scores were estimated using histology scores. The DOPU score is the percentage of fibrous tissues in the liver tissue samples. The histology score is a standard score obtained from the histology stain by a pathologist. The correlation is the linear fitting used to correlate the DOPU and Histology scores (FIG. 26).

### CONCLUSIONS

At least the following conclusions can be arrived at from the present results.

Liver Tissue Heterogeneity. The quality distributions of steatosis and fibrosis in human liver tissues are heterogeneous. One piece of liver tissue cannot be assumed to be characteristic of the entire liver for quality assessment in histology. The evaluation of multiple locations of the liver are necessary to assess the entire liver's quality by histology.

Noninvasive Steatosis Imaging by OCT. OCT intensity image can noninvasively observe steatosis structures for the entire liver. Deep learning models can be used to automatically recognize steatosis structures and quantify the density. By combining texture and toughness features, OCT images can provide correlative steatosis quantification information.

Noninvasive Fibrosis Imaging by PS-OCT. PS-OCT images provide fibrosis distribution characterizations and quantifications of liver tissues. PS-OCT images can accurately detect the degree of fibrosis, achieving an 85% accuracy rate for noninvasive mapping of fibrosis distribution.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
1. Broering, D. C., M. Sterneck, and X. Rogiers, Living donor liver transplantation. Journal of hepatology, 2003. 38: p. 119-135.
2. Schaubel, D. E., et al., The survival benefit of deceased donor liver transplantation as a function of candidate disease severity and donor quality. American journal of transplantation, 2008. 8(2): p. 419-425.
3. Terrault, N. A., et al., Liver Transplantation 2023: Status Report, Current and Future Challenges. Clinical Gastroenterology and Hepatology, 2023.
4. Jadlowiec, C. C. and T. Taner, Liver transplantation: current status and challenges. World journal of gastroenterology, 2016. 22(18): p. 4438.
5. Maluf, D. G., et al., Adult living donor versus deceased donor liver transplantation: a 6-year single center experience. American Journal of Transplantation, 2005. 5(1): p. 149-156.
6. Feng, S., et al., Characteristics associated with liver graft failure: the concept of a donor risk index. American journal of transplantation, 2006. 6(4): p. 783-790.
7. Flores, A. and S. K. Asrani, The donor risk index: a decade of experience. Liver Transplantation, 2017. 23(9): p. 1216-1225.
8. Melin, C., et al., Approach to intraoperative consultation for donor liver biopsies. Archives of pathology & laboratory medicine, 2013. 137(2): p. 270-274.
9. D′Alessandro, A. M., et al., The predictive value of donor liver biopsies for the development of primary nonfunction after orthotopic liver transplantation. Transplantation, 1991. 51(1): p. 157-163.
10. Nassir, F., et al., Pathogenesis and prevention of hepatic steatosis. Gastroenterology & hepatology, 2015. 11(3): p. 167.
11. Selzner, M. and P.-A. Clavien, Failure of regeneration of the steatotic rat liver: disruption at two different levels in the regeneration pathway. Hepatology, 2000. 31(1): p. 35-42.
12. Marsman, W. A., et al., Use of fatty donor liver is associated with diminished early patient and graft survival. Transplantation, 1996. 62(9): p. 1246-1251.
13. Brandhagen, D., J. Fidler, and C. Rosen, Evaluation of the donor liver for living donor liver transplantation. Liver transplantation, 2003. 9(10): p. S16-S28.
14. Neil, D. A., et al., Banff consensus recommendations for steatosis assessment in donor livers. Hepatology, 2022. 75(4): p. 1014-1025.
15. Busuttil, R. W. and K. Tanaka, The utility of marginal donors in liver transplantation. Liver transplantation, 2003. 9(7): p. 651-663.
16. Loinaz, C. and E. M. Gonzalez, Marginal donors in liver transplantation. Hepato-gastroenterology, 2000. 47(31): p. 256-263.
17. de Graaf, E. L., et al., Grade of deceased donor liver macrovesicular steatosis impacts graft and recipient outcomes more than the Donor Risk Index. Journal of gastroenterology and hepatology, 2012. 27(3): p. 540-546.
18. Hwang, S., et al., The effect of donor weight reduction on hepatic steatosis for living donor liver transplantation. Liver transplantation, 2004. 10(6): p. 721-725.
19. Jun, M. J., et al., Clinical implications of preoperative and intraoperative liver biopsies for evaluating donor steatosis in living related liver transplantation. Liver Transplantation, 2014. 20(4): p. 437-445.
20. Imber, C. J., et al., Current practice regarding the use of fatty livers: a trans-Atlantic survey. Liver Transplantation, 2002. 8(6): p. 545-549.
21. Ploeg, R. J., et al., Risk factors for primary dysfunction after liver transplantation-a multivariate analysis. Transplantation, 1993. 55(4): p. 807-813.
22. Spitzer, A. L., et al., The biopsied donor liver: incorporating macrosteatosis into high-risk donor assessment. Liver Transplantation, 2010. 16(7): p. 874-884.
23. Limanond, P., et al., Macrovesicular hepatic steatosis in living related liver donors: correlation between CT and histologic findings. Radiology, 2004. 230(1): p. 276-280.
24. Berumen, J., et al., Liver fibrosis: Pathophysiology and clinical implications. WIREs mechanisms of disease, 2021. 13(1): p. e1499.
25. Wadhera, V., et al., The impact of donor liver allograft fibrosis on patients undergoing liver transplantation. Clinical Transplantation, 2018. 32(3): p. e13187.
26. Haga, H., et al., Periportal edema and necrosis as diagnostic histological features of early humoral rejection in ABO-incompatible liver transplantation. Liver transplantation, 2004. 10(1): p. 16-27.
27. Clark, I. and M. S. Torbenson, Immunohistochemistry and special stains in medical liver pathology. Advances in anatomic pathology, 2017. 24(2): p. 99-109.
28. Lefkowitch, J. H., Scheuer's liver biopsy interpretation E-Book. 2015: Elsevier Health Sciences.
29. Johnson, W. W., et al., Ultrastructure of malignant histiocytoma arising in the acromion. Human Pathology, 1978. 9(2): p. 199-209.
30. Huang, D., et al., Optical coherence tomography. science, 1991. 254(5035): p. 1178-1181.
31. Hee, M. R., et al., Optical coherence tomography of the human retina. Archives of ophthalmology, 1995. 113(3): p. 325-332.
32. Vakoc, B. J., et al., Cancer imaging by optical coherence tomography: preclinical progress and clinical potential. Nature Reviews Cancer, 2012. 12(5): p. 363-368.
33. Andrews, P. M., et al., High-resolution optical coherence tomography imaging of the living kidney. Laboratory investigation, 2008. 88(4): p. 441-449.
34. Zhu, Y., et al., Rapid and high-resolution imaging of human liver specimens by full-field optical coherence tomography. Journal of biomedical optics, 2015. 20(11): p. 116010-116010.
35. Tsuboi, M., et al., Optical coherence tomography in the diagnosis of bronchial lesions. Lung cancer, 2005. 49(3): p. 387-394.
36. Yabushita, H., et al., Characterization of human atherosclerosis by optical coherence tomography. Circulation, 2002. 106(13): p. 1640-1645.
37. Jia, Y., et al., Quantitative optical coherence tomography angiography of vascular abnormalities in the living human eye. Proceedings of the National Academy of Sciences, 2015. 112(18): p. E2395-E2402.
38. Otis, L. L., et al., Optical coherence tomography: a new imaging: technology for dentistry. The Journal of the American Dental Association, 2000. 131(4): p. 511-514.
39. Chen, Y., et al., High-resolution three-dimensional optical coherence tomography imaging of kidney microanatomy ex vivo. Journal of biomedical optics, 2007. 12(3): p. 034008-034008-7.
40. Ducros, M. G., et al., Polarization sensitive optical coherence tomography of the rabbit eye. IEEE Journal of Selected Topics in Quantum Electronics, 1999. 5(4): p. 1159-1167.
41. De Boer, J. F., C. K. Hitzenberger, and Y. Yasuno, Polarization sensitive optical coherence tomography-a review. Biomedical optics express, 2017. 8(3): p. 1838-1873.
42. Yan, F., et al., Polarization-sensitive optical coherence tomography for renal tumor detection in ex vivo human kidneys. Optics and Lasers in Engineering, 2024. 173: p. 107900.
43. Yan, F., et al., Optical coherence tomography for multicellular tumor spheroid category recognition and drug screening classification via multi-spatial-superficial-parameter and machine learning. Biomedical Optics Express, 2024. 15(4): p. 2014-2047.
44. J. F. De Boer, C. K. Hitzenberger, Y. Yasuno, Polarization sensitive optical coherence tomography-a review. Biomedical optics express 8, 1838-1873(2017).
45. Z. Wang, A. C. Bovik, H. R. Sheikh, E. P. Simoncelli, Image quality assessment: from error visibility to structural similarity. IEEE transactions on image processing 13, 600-612(2004).
46. K. He, X. Zhang, S. Ren, J. Sun, in Proceedings of the IEEE conference on computer vision and pattern recognition. (2016), pp. 770-778.
47. A. Kirillov et al., in Proceedings of the IEEE/CVF International Conference on Computer Vision. (2023), pp. 4015-4026.
48. P. Isola, J.-Y. Zhu, T. Zhou, A. A. Efros, in Proceedings of the IEEE conference on computer vision and pattern recognition. (2017), pp. 1125-1134.
49. O. Ronneberger, P. Fischer, T. Brox, in Medical image computing and computer-assisted intervention-MICCAI 2015: 18th international conference, Munich, Germany, Oct. 5-9, 2015, proceedings, part III 18. (Springer, 2015), pp. 234-241.
50. D. C. Broering, M. Sterneck, X. Rogiers, Living donor liver transplantation. Journal of hepatology 38, 119-135(2003).
51. D. E. Schaubel, C. Sima, N. P. Goodrich, S. Feng, R. M. Merion, The survival benefit of deceased donor liver transplantation as a function of candidate disease severity and donor quality. American journal of transplantation 8, 419-425(2008).
52. N. A. Terrault, C. Francoz, M. Berenguer, M. Charlton, J. Heimbach, Liver Transplantation 2023: Status Report, Current and Future Challenges. Clinical Gastroenterology and Hepatology, (2023).
53. H. R. S. Administration, Organ Donation Statistics. Health Resources & Services Administration, (2024).
54. C. C. Jadlowiec, T. Taner, Liver transplantation: current status and challenges. World journal of gastroenterology 22, 4438(2016).
55. N. A. Terrault, C. Francoz, M. Berenguer, M. Charlton, J. Heimbach, Liver Transplantation 2023: Status Report, Current and Future Challenges. Clinical Gastroenterology and Hepatology 21, 2150-2166(2023).
56. D. G. Maluf et al., Adult living donor versus deceased donor liver transplantation: a 6-year single center experience. American Journal of Transplantation 5, 149-156 (2005).
57. M. Selzner, P.-A. Clavien, in Seminars in liver disease. (Copyright@ 2001 by Thieme Medical Publishers, Inc., 333 Seventh Avenue, New . . . , 2001), vol. 21, pp. 105-114.
58. L. McCormack et al., Use of severely steatotic grafts in liver transplantation: a matched case-control study. Annals of surgery 246, 940-948(2007).
59. J. W. Kupiec-Weglinski, R. Busuttil, in Transplantation proceedings. (Elsevier, 2005), vol. 37, pp. 1653-1656.
60. J. Eden et al., Utilization of livers donated after circulatory death for transplantation—An international comparison. Journal of hepatology 78, 1007-1016 (2023).
61. I. Vodkin, A. Kuo, Extended criteria donors in liver transplantation. Clinics in liver disease 21, 289-301(2017).
62. S. Feng et al., Characteristics associated with liver graft failure: the concept of a donor risk index. American journal of transplantation 6, 783-790(2006).
63. A. Flores, S. K. Asrani, The donor risk index: a decade of experience. Liver Transplantation 23, 1216-1225(2017).
64. C. Melin, R. Miick, N. A. Young, J. Ortiz, M. Balasubramanian, Approach to intraoperative consultation for donor liver biopsies. Archives of pathology & laboratory medicine 137, 270-274(2013).
65. A. M. D'Alessandro et al., The predictive value of donor liver biopsies for the development of primary nonfunction after orthotopic liver transplantation. Transplantation 51, 157-163(1991).
66. F. Nassir, R. S. Rector, G. M. Hammoud, J. A. Ibdah, Pathogenesis and prevention of hepatic steatosis. Gastroenterology & hepatology 11, 167(2015).
67. M. Selzner, P.-A. Clavien, Failure of regeneration of the steatotic rat liver: disruption at two different levels in the regeneration pathway. Hepatology 31, 35-42 (2000).
68. W. A. Marsman et al., Use of fatty donor liver is associated with diminished early patient and graft survival. Transplantation 62, 1246-1251(1996).
69. D. Brandhagen, J. Fidler, C. Rosen, Evaluation of the donor liver for living donor liver transplantation. Liver transplantation 9, S16-S28(2003).
70. D. A. Neil et al., Banff consensus recommendations for steatosis assessment in donor livers. Hepatology 75, 1014-1025(2022).
71. R. W. Busuttil, K. Tanaka, The utility of marginal donors in liver transplantation. Liver transplantation 9, 651-663(2003).
72. C. Loinaz, E. M. Gonzalez, Marginal donors in liver transplantation. Hepato-gastroenterology 47, 256-263(2000).
73. J. Berumen, J. Baglieri, T. Kisseleva, K. Mekeel, Liver fibrosis: Pathophysiology and clinical implications. WIREs mechanisms of disease 13, e1499(2021).
74. V. Wadhera et al., The impact of donor liver allograft fibrosis on patients undergoing liver transplantation. Clinical Transplantation 32, e13187(2018).
75. H. Haga et al., Periportal edema and necrosis as diagnostic histological features of early humoral rejection in ABO-incompatible liver transplantation. Liver transplantation 10, 16-27(2004).
76. D. A. Neil, S. G. Hübscher, Current views on rejection pathology in liver transplantation. Transplant international 23, 971-983(2010).
77. I. Clark, M. S. Torbenson, Immunohistochemistry and special stains in medical liver pathology. Advances in anatomic pathology 24, 99-109(2017).
78. J. H. Lefkowitch, Scheuer's liver biopsy interpretation E-Book. (Elsevier Health Sciences, 2015).
79. W. W. Johnson et al., Ultrastructure of malignant histiocytoma arising in the acromion. Human Pathology 9, 199-209(1978).
80. L. S. Friedman, Controversies in liver biopsy: who, where, when, how, why? Current gastroenterology reports 6, 30-36(2004).
81. A. Regev et al., Sampling error and intraobserver variation in liver biopsy in patients with chronic HCV infection. The American journal of gastroenterology 97, 2614-2618(2002).
82. D. Huang et al., Optical coherence tomography. science 254, 1178-1181(1991).
83. M. R. Hee et al., Optical coherence tomography of the human retina. Archives of ophthalmology 113, 325-332(1995).
84. B. J. Vakoc, D. Fukumura, R. K. Jain, B. E. Bouma, Cancer imaging by optical coherence tomography: preclinical progress and clinical potential. Nature Reviews Cancer 12, 363-368(2012).
85. P. M. Andrews et al., High-resolution optical coherence tomography imaging of the living kidney. Laboratory investigation 88, 441-449(2008).
86. Y. Zhu et al., Rapid and high-resolution imaging of human liver specimens by full-field optical coherence tomography. Journal of biomedical optics 20, 116010-116010 (2015).
87. M. Tsuboi et al., Optical coherence tomography in the diagnosis of bronchial lesions. Lung cancer 49, 387-394(2005).
88. H. Yabushita et al., Characterization of human atherosclerosis by optical coherence tomography. Circulation 106, 1640-1645(2002).
89. Y. Jia et al., Quantitative optical coherence tomography angiography of vascular abnormalities in the living human eye. Proceedings of the National Academy of Sciences 112, E2395-E2402(2015).
90. L. L. Otis, M. J. Everett, U. S. Sathyam, B. W. Colston Jr, Optical coherence tomography: a new imaging: technology for dentistry. The Journal of the American Dental Association 131, 511-514(2000).
91. Y. Chen, P. M. Andrews, A. D. Aguirre, J. M. Schmitt, J. G. Fujimoto, High-resolution three-dimensional optical coherence tomography imaging of kidney microanatomy ex vivo. Journal of biomedical optics 12, 034008-034008-034007(2007).
92. M. G. Ducros et al., Polarization sensitive optical coherence tomography of the rabbit eye. IEEE Journal of Selected Topics in Quantum Electronics 5, 1159-1167(1999).
93. J. F. De Boer, C. K. Hitzenberger, Y. Yasuno, Polarization sensitive optical coherence tomography-a review. Biomedical optics express 8, 1838-1873(2017).
94. D. E. Kleiner et al., Design and validation of a histological scoring system for nonalcoholic fatty liver disease. Hepatology 41, 1313-1321(2005).
95. I. Hejlova et al., Prevalence and risk factors of steatosis after liver transplantation and patient outcomes. Liver Transplantation 22, 644-655(2016).
96. K. Jungermann, D. Sasse, Heterogeneity of liver parenchymal cells. Trends in Biochemical Sciences 3, 198-202(1978).
97. H. Tian et al., Multimodal mass spectrometry imaging identifies cell-type-specific metabolic and lipidomic variation in the mammalian liver. Developmental Cell 59, 869-881. e866(2024).
98. J. Xin et al., Spatial transcriptomics analysis of zone-dependent hepatic ischemia-reperfusion injury murine model. Communications Biology 6, 194(2023).
99. G. J. Ooi et al., Evaluation of the histological variability of core and wedge biopsies in nonalcoholic fatty liver disease in bariatric surgical patients. Surgical Endoscopy 35, 1210-1218(2021).
100. D. Sasse, N. Katz, K. Jungermann, Functional heterogeneity of rat liver parenchyma and of isolated hepatocytes. FEBS letters 57, 83-88(1975).
101. D. Martínez-Torres et al., Phenotypic characterization of liver tissue heterogeneity through a next-generation 3D single-cell atlas. Scientific reports 14, 2823(2024).
102. W. Hołówko et al., in Transplantation Proceedings. (Elsevier, 2014), vol. 46, pp. 2755-2757.
103. M. J. Lee et al., Liver steatosis assessment: correlations among pathology, radiology, clinical data and automated image analysis software. Pathology-Research and Practice 209, 371-379(2013).
104. E. D′Alessandro, F. Calabrese, E. Gringeri, M. Valente, in Transplantation proceedings. (Elsevier, 2010), vol. 42, pp. 2226-2228.
105. B. Terjung et al., Bleeding complications after percutaneous liver biopsy: an analysis of risk factors. Digestion 67, 138-145(2003).
106. J. Sampaio-Neto et al., Prospective Study to Analyze the Concordance Between a Standardized Visual Method With Pathology to stratify Nonalcoholic Fatty Liver Disease in Cadaveric Liver Grafts Evaluated for Transplantation. Transplantation direct 9, e1540 (2023).
107. I. M. Brüggenwirth, O. B. van Leeuwen, R. J. Porte, P. N. Martins, The emerging role of viability testing during liver machine perfusion. Liver Transplantation 28, 876-886 (2022).
108. B. Konkel et al., Fully automated analysis of OCT imaging of human kidneys for prediction of post-transplant function. Biomedical optics express 10, 1794-1821(2019).
109. E. M. Brunt, C. G. Janney, A. M. Di Bisceglie, B. A. Neuschwander-Tetri, B. R. Bacon, Nonalcoholic steatohepatitis: a proposal for grading and staging the histological lesions. Official journal of the American College of Gastroenterologyl ACG 94, 2467-2474(1999).
110. E. L. de Graaf et al., Grade of deceased donor liver macrovesicular steatosis impacts graft and recipient outcomes more than the Donor Risk Index. Journal of gastroenterology and hepatology 27, 540-546(2012).
111. S. Hwang et al., The effect of donor weight reduction on hepatic steatosis for living donor liver transplantation. Liver transplantation 10, 721-725(2004).
112. M. J. Jun et al., Clinical implications of preoperative and intraoperative liver biopsies for evaluating donor steatosis in living related liver transplantation. Liver Transplantation 20, 437-445(2014).
113. C. J. Imber, S. D. S. Peter, I. Lopez, L. Guiver, P. J. Friend, Current practice regarding the use of fatty livers: a trans-Atlantic survey. Liver Transplantation 8, 545-549 (2002).
114. R. J. Ploeg et al., Risk factors for primary dysfunction after liver transplantation a multivariate analysis. Transplantation 55, 807-813(1993).
115. A. L. Spitzer et al., The biopsied donor liver: incorporating macrosteatosis into high-risk donor assessment. Liver Transplantation 16, 874-884(2010).
116. P. Limanond et al., Macrovesicular hepatic steatosis in living related liver donors: correlation between CT and histologic findings. Radiology 230, 276-280(2004).
117. M. Rubinstein et al., Intraoperative use of optical coherence tomography to differentiate normal and diseased thyroid and parathyroid tissues from lymph node and fat. Lasers in medical science 36, 269-278(2021).
118. C. Kut et al., Detection of human brain cancer infiltration ex vivo and in vivo using quantitative optical coherence tomography. Science translational medicine 7, 292ra100-292ra100(2015).
119. C. Trautwein, S. L. Friedman, D. Schuppan, M. Pinzani, Hepatic fibrosis: concept to treatment. Journal of hepatology 62, S15-S24(2015).
120. G. Ramadori, B. Saile, Portal tract fibrogenesis in the liver. Laboratory investigation 84, 153-159(2004).
121. R. K. Dhiman et al., Non-cirrhotic portal fibrosis (idiopathic portal hypertension): experience with 151 patients and a review of the literature. Journal of gastroenterology and hepatology 17, 6-16(2002).
122. M. J. Lee, A review of liver fibrosis and cirrhosis regression. Journal of pathology and translational medicine 57, 189-195(2023).
123. K. T. Suk, D. J. Kim, Staging of liver fibrosis or cirrhosis: The role of hepatic venous pressure gradient measurement. World journal of hepatology 7, 607-615(2015).
124. L. P. Hariri et al., Distinguishing tumor from associated fibrosis to increase diagnostic biopsy yield with polarization-sensitive optical coherence tomography. Clinical Cancer Research 25, 5242-5249(2019).
125. Y. N. Zhang et al., Liver fibrosis imaging: A clinical review of ultrasound and magnetic resonance clastography. Journal of magnetic resonance imaging: JMRI 51, 25-42(2020).
126. S. C. Faria et al., MR imaging of liver fibrosis: current state of the art. Radiographics: a review publication of the Radiological Society of North America, Inc 29, 1615-1635(2009).
127. A. D. Smith, K. K. Porter, A. A. Elkassem, R. Sanyal, M. E. Lockhart, Current Imaging Techniques for Noninvasive Staging of Hepatic Fibrosis. American Journal of Roentgenology 213, 77-89(2019).
128. S. Yamamoto et al., Quantitative imaging of fibrotic and morphological changes in liver of non-alcoholic steatohepatitis (NASH) model mice by second harmonic generation (SHG) and auto-fluorescence (AF) imaging using two-photon excitation microscopy (TPEM). Biochemistry and Biophysics Reports 8, 277-283(2016).
129. N. Fan et al., Rapid two-photon fluorescence imaging of monoamine oxidase B for diagnosis of early-stage liver fibrosis in mice. Analytical Chemistry 93, 7110-7117 (2021).
130. S. Han, L. Yang, M. Liu, H. Li, X. Song, Accurate diagnosis of hepatic fibrosis with dual detection of nitric oxide and viscosity by a ratiometric fluorescent probe. Chemical Engineering Journal 463, 142383(2023).
131. V. V. Tuchin et al., Light propagation in tissues with controlled optical properties. Journal of biomedical optics 2, 401-417(1997).
132. L. Ruiz, A. Fdez-Sarría, J. Recio, in 20th ISPRS Congress. (2004), vol. 35, pp. 1109-1114.
133. J. Yuan, D. Wang, R. Li, Remote sensing image segmentation by combining spectral and texture features. IEEE Transactions on geoscience and remote sensing 52, 16-24(2013).
134. A. Kassner, R. Thornhill, Texture analysis: a review of neurologic MR imaging applications. American Journal of Neuroradiology 31, 809-816(2010).
135. A. Depeursinge, A. Foncubierta-Rodriguez, D. Van De Ville, H. Müller, Three-dimensional solid texture analysis in biomedical imaging: review and opportunities. Medical image analysis 18, 176-196(2014).
136. M. Krishna, Patterns of necrosis in liver disease. Clinical liver disease 10, 53-56 (2017).
137. H. Mergental et al., Transplantation of discarded livers following viability testing with normothermic machine perfusion. Nature communications 11, 2939(2020).
138. P.-A. Clavien, H. Petrowsky, M. L. DeOliveira, R. Graf, Strategies for safer liver surgery and partial liver transplantation. New England Journal of Medicine 356, 1545-1559(2007).
139. P. A. Clavien et al., What is critical for liver surgery and partial liver transplantation: size or quality? Hepatology 52, 715-729(2010).
140. D. F. Mirza et al., Policies in Europe on “marginal quality” donor livers. The Lancet 344, 1480-1483(1994).
141. M. Yamanaka, T. Teranishi, H. Kawagoe, N. Nishizawa, Optical coherence microscopy in 1700 nm spectral band for high-resolution label-free deep-tissue imaging. Scientific reports 6, 31715(2016).
142. P. Li et al., Extended imaging depth to 12 mm for 1050-nm spectral domain optical coherence tomography for imaging the whole anterior segment of the human eye at 120-kHz A-scan rate. Journal of Biomedical Optics 18, 016012-016012(2013).
143. A. Badon et al., Smart optical coherence tomography for ultra-deep imaging through highly scattering media. Science advances 2, e1600370(2016).
144. M. G. Gräfe et al., Subretinal fibrosis detection using polarization sensitive optical coherence tomography. Translational vision science & technology 9, 13-13 (2020).
145. B. Braaf, K. A. Vermeer, M. de Groot, K. V. Vienola, J. F. de Boer, Fiber-based polarization-sensitive OCT of the human retina with correction of system polarization distortions. Biomedical optics express 5, 2736-2758(2014).
146. F. Yan et al., Polarization-sensitive optical coherence tomography for renal tumor detection in ex vivo human kidneys. Optics and Lasers in Engineering 173, 107900 (2024).
147. M. Villiger et al., Deep tissue volume imaging of birefringence through fibre-optic needle probes for the delineation of breast tumour. Scientific reports 6, 28771 (2016).
148. F. Feroldi et al., In vivo multifunctional optical coherence tomography at the periphery of the lungs. Biomedical optics express 10, 3070-3091(2019).
149. P. Tang et al., Polarization sensitive optical coherence tomography with single input for imaging depth-resolved collagen organizations. Light: Science & Applications 10, 237(2021).
150. Y. Huang et al., Wide-field high-speed space-division multiplexing optical coherence tomography using an integrated photonic device. Biomedical optics express 8, 3856-3867(2017).
151. C. Zhou, A. Alex, J. Rasakanthan, Y. Ma, Space-division multiplexing optical coherence tomography. Optics express 21, 19219-19227(2013).
152. J. B. Jeppesen, C. Mortensen, F. Bendtsen, S. Møller, Lactate metabolism in chronic liver disease. Scandinavian journal of clinical and laboratory investigation 73, 293-299(2013).
153. P. Mukherjee et al., Label-free metabolic imaging of non-alcoholic-fatty-liver-disease (NAFLD) liver by volumetric dynamic optical coherence tomography. Biomedical Optics Express 13, 4071-4086(2022).
154. R. X. Sousa Da Silva, A. Weber, P. Dutkowski, P. A. Clavien, Machine perfusion in liver transplantation. Hepatology 76, 1531-1549(2022).
155. R. A. Leitgeb, R. M. Werkmeister, C. Blatter, L. Schmetterer, Doppler optical coherence tomography. Progress in retinal and eye rescarch 41, 26-43(2014).

1. A computer-implemented method performed by at least one processor to conduct a non-invasive evaluation of a liver prior to a transplantation procedure the method comprising:
providing a polarization-sensitive optical coherence tomography (PS-OCT) system, wherein the PS-OCT system is coupled to a machine-learning-based system trained to evaluate PC-OCT images of liver;
using the PC-OCT system to provide a set of intensity and polarization images obtained from a plurality of sites on the liver to identify hepatic microstructures related to steatosis, fibrosis, inflammation, and necrosis in the liver;
determining steatosis, fibrosis, inflammation, and necrosis scores for the liver;
determining whether the liver is suitable for use as a donor liver when the steatosis, fibrosis, inflammation, and necrosis scores meet predetermined donor suitability criteria;
determining whether the liver is unsuitable for use as a donor liver when the steatosis, fibrosis, inflammation, and necrosis scores fail to meet predetermined donor suitability criteria; and,
maintaining the liver under proper preservation conditions when the liver is determined to be suitable for use as a donor liver.

2. The method of claim 1, wherein the PS-OCT system further comprises:
a broadband light source having a center wavelength of 1300 nm and configured to emit linear-polarized light;
a polarization controller optically coupled to the broad band light source configured to adjust the polarization state of the emitted light;
a polarizer optically coupled to the polarization controller to ensure a defined linear polarization state;
a circulator optically coupled to the polarizer to direct light flow; and,
a fiber-to-free space collimator optically coupled to the circulator to transition light from fiber to free space.

3. The method of claim 2, wherein the PS-OCT system further comprises:
a beam splitter optically couple dot the fiber-to free-space collimator, configured such that the beam splitter divides the light into sample arm and a reference arm.

4. The method of claim 3, wherein the sample arm comprises an adjustable iris to control the beam size and a first quarter-wave plate oriented at a predetermined angle to modify the polarization state of light.

5. The method of claim 4, wherein the predetermined angle to modify the polarization state of light is 22.5 degrees.

6. The method of claim 3, wherein the sample arm further comprises a second quarter-wave (QWP 2) oriented at 45 degrees to further manipulate the polarization state;
a galvo mirror to steer the light beam; and,
a predetermined instruction configured to focus the light onto a sample, wherein the sample arm is configured to produce circularly polarized incident light on the sample arm with equal amplitude in both orthogonal polarizations.

7. The method of claim 3, wherein the PS-OCT system further comprises:
a mirror configured to reflect the light back to the beam splitter, configured to enable interference with light from the sample arm; and,
the interfered light is directed back through the beam splitter and fiber-to-free space collimator to the circulator.

8. The method of claim 2, further comprising:
a polarization-sensitive beam splitter optically coupled to receive interfered light from the circulator by the fiber-to-free-space collimator; and,
a first channel sensor and a second channel sensor optically coupled to polarization-sensitive beam splitter to detect intensity and polarization information from the sample.

9. The method of claim 1, further comprising the step of preparing the liver with multiple position labeling to create a set of labeled positions.

10. The method of claim 9, further comprises the step of PS-OCT scanning each labeled position.

11. The method of claim 1, further comprising the step of transplanting the liver into a transplant recipient when the liver is determined to be suitable for use as a donor liver.

12. A method of storing a liver for a transplantation procedure, comprising:
providing a deceased donor liver, wherein the deceased donor liver is stored in a storage apparatus for preserving the liver prior to the transplantation procedure;
providing a polarization-sensitive optical coherence tomography (PS-OCT) system, wherein the PS-OCT system is coupled to a machine-learning-based system trained to evaluate PC-OCT images of liver;
using the PC-OCT system to provide a set of intensity and polarization images obtained from a plurality of sites on the liver to identify hepatic microstructures related to steatosis, fibrosis, inflammation, and necrosis in the liver;
determining steatosis, fibrosis, inflammation, and necrosis scores for the liver; and
returning the deceased donor liver to the storage apparatus for continued preservation prior to the transplantation procedure.

13. The method of claim 12, wherein the PS-OCT system further comprises:
a broadband light source having a center wavelength of 1300 nm and configured to emit linear-polarized light;
a polarization controller optically coupled to the broad band light source configured to adjust the polarization state of the emitted light;
a polarizer optically coupled to the polarization controller to ensure a defined linear polarization state;
a circulator optically coupled to the polarizer to direct light flow; and,
a fiber-to-free space collimator optically coupled to the circulator to transition light from fiber to free space.

14. The method of claim 13, wherein the PS-OCT system further comprises:
a beam splitter optically couple dot the fiber-to free-space collimator, configured such that the beam splitter divides the light into sample arm and a reference arm.

15. The method of claim 14, wherein the sample arm comprises an adjustable iris to control the beam size and a first quarter-wave plate oriented at a predetermined angle to modify the polarization state of light.

16. The method of claim 15, wherein the predetermined angle to modify the polarization state of light is 22.5 degrees.

17. The method of claim 14, wherein the sample arm further comprises a second quarter-wave (QWP 2) oriented at 45 degrees to further manipulate the polarization state;
a galvo mirror to steer the light beam; and,
a predetermined instruction configured to focus the light onto a sample, wherein the sample arm is configured to produce circularly polarized incident light on the sample arm with equal amplitude in both orthogonal polarizations.

18. The method of claim 14, wherein the PS-OCT system further comprises:
a mirror configured to reflect the light back to the beam splitter, configured to enable interference with light from the sample arm; and,
the interfered light is directed back through the beam splitter and fiber-to-free space collimator to the circulator.

19. The method of claim 14, further comprising the step of transplanting the deceased donor liver into a transplant recipient.

20. A system comprising:
a data store comprising a program of instructions; and,
a processor operably coupled to the data store such that, when the processor executes the programs of instructions, the processor operations to be performed to conduct a non-invasive evaluation of a liver prior to a transplantation procedure, the method comprising:
providing a polarization-sensitive optical coherence tomography (PS-OCT) system, wherein the PS-OCT system is coupled to a machine-learning-based system trained to evaluate PC-OCT images of liver;
using the PC-OCT system to provide a set of intensity and polarization images obtained from a plurality of sites on the liver to identify hepatic microstructures related to steatosis, fibrosis, inflammation, and necrosis in the liver;
determining steatosis, fibrosis, inflammation, and necrosis scores for the liver;
determining whether the liver is suitable for use as a donor liver when the steatosis, fibrosis, inflammation, and necrosis scores meet predetermined donor suitability criteria;
determining whether the liver is unsuitable for use as a donor liver when the steatosis, fibrosis, inflammation, and necrosis scores fail to meet predetermined donor suitability criteria; and,
maintaining the liver under proper preservation conditions when the liver is determined to be suitable for use as a donor liver;
wherein the PS-OCT system further comprises:
a broadband light source and configured to emit linear-polarized light;
a polarization controller optically coupled to the broadband light source configured to adjust the polarization state of the emitted light;
a polarizer optically coupled to the polarization controller to ensure a defined linear polarization state; and,
a circulator optically coupled to the polarizer to direct light flow.
